(19) United States
(12) Patent Application Publication
(10) Pub. No.: US 2025/0264723 A1
(43) Pub. Date: Aug. 21, 2025

(54) STACKED WAVEGUIDES FOR UNIFORM PUPIL REPLICATION AND EYEBOX EXPANSION

(71) Applicant: Meta Platforms Technologies, LLC, Menlo Park, CA (US)

(72) Inventors: Georgios SKOLIANOS, Seattle, WA (US); David BAJORINS, Snohomish, WA (US)

(21) Appl. No.: 19/033,090

(22) Filed: Jan. 21, 2025

(30) Foreign Application Priority Data
Feb. 16, 2024 (GR) 20240100120

(51) Int. Cl. G02B 27/01; G02B 27/00

(52) U.S. Cl. CPC G02B 27/0172; G02B 27/0081; G02B 27/0093; G02B 2027/011; G02B 2027/0178

(57) ABSTRACT

Disclosed herein are pupil expanders for pupil replication in near-eye display systems. In some examples, a pupil expander includes a waveguide and a variable reflectivity transflective mirror, where display light propagating in the waveguide is transmitted through a plurality of regions of the variable reflectivity transflective mirror to form a plurality of replicas of the pupil along one direction. Two such pupil expanders can be used to replicate the pupil in two directions. In some examples, a pupil expander includes a waveguide, an output coupler formed on or in the waveguide, and two or more transflective mirrors in the waveguide and parallel to a surface the waveguide for improving the pupil replication density and light intensity uniformity of the eyebox.

### CROSS-REFERENCE TO RELATED APPLICATION

This application claims priority to Greek Patent Application No. 20240100120, filed Feb. 16, 2024, entitled “STACKED WAVEGUIDES FOR UNIFORM PUPIL REPLICATION AND EYEBOX EXPANSION,” which is assigned to the assignee hereof and is hereby incorporated by reference in its entirety.

### BACKGROUND

An artificial reality system, such as a head-mounted display (HMD) or heads-up display (HUD) system, generally includes a near-eye display (e.g., in the form of a headset or a pair of glasses) configured to present content to a user via an electronic or optic display within, for example, about 10 to 20 mm in front of the user's eyes. The near-eye display may display virtual objects or combine images of real objects with virtual objects, as in virtual reality (VR), augmented reality (AR), or mixed reality (MR) applications. For example, in an AR system, a user may view both images of virtual objects (e.g., computer-generated images (CGIs)), and the surrounding environment by, for example, seeing through transparent display glasses or lenses (often referred to as optical see-through) or viewing displayed images of the surrounding environment captured by a camera (often referred to as video see-through).

A near-eye display may include an optical system configured to form an image of a computer-generated image on an image plane. The optical system of the near-eye display may relay the image generated by an image source (e.g., a display panel) to create a virtual image that appears to be away from the image source and further than just a few centimeters away from the user's eyes. For example, the optical system may collimate the light from the image source or otherwise convert spatial information of the displayed virtual objects into angular information to create a virtual image that may appear to be far away. The optical system may also magnify the image source to make the image appear larger than the actual size of the image source. It is generally desirable that the near-eye display has a small size, a low weight, a large field of view, a large eyebox, a high efficiency, and a low cost.

### SUMMARY

This disclosure relates generally to near-eye display systems. More specifically, disclosed herein are pupil expanders for pupil replication in near-eye display systems. Various inventive embodiments are described herein, including devices, components, systems, modules, assemblies, subsystems, and the like.

According to certain embodiments, a pupil expander of a near-eye display may include a waveguide transparent to display light and configured to guide the display light along a first direction, and a partial reflective mirror on a first surface of the waveguide. The partial reflective mirror may be parallel to the first direction and may be characterized by different reflectivity at a plurality of regions along the first direction. Each region of the plurality of regions of the partial reflective mirror may be configured to partially reflect incident light and partially transmit the incident light through the region of the plurality of regions of the partial reflective mirror.

According to certain embodiments, a near-eye display may include a first pupil expander and a second pupil expander. The first pupil expander may extend in a first direction and may include a first waveguide transparent to display light and configured to guide the display light along the first direction, and a first partial reflective mirror on a first surface of the first waveguide. The first partial reflective mirror may be parallel to the first direction and may be characterized by different reflectivity at a first plurality of regions along the first direction. Each region of the first plurality of regions of the first partial reflective mirror may be configured to partially reflect incident light and partially transmit the incident light through the region of the first plurality of regions of the first partial reflective mirror. The second pupil expander may be configured to split the display light transmitted from each region of the first plurality of regions of the first partial reflective mirror at a second plurality of regions along a second direction that is different from the first direction.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

Illustrative embodiments are described in detail below with reference to the following figures.

FIG. 1 is a simplified block diagram of an example of an artificial reality system environment including a near-eye display according to certain embodiments.

FIG. 2 is a perspective view of an example of a near-eye display in the form of a head-mounted display (HMD) device for implementing some of the examples disclosed herein.

FIG. 3 is a perspective view of an example of a near-eye display in the form of a pair of glasses for implementing some of the examples disclosed herein.

FIG. 4 illustrates an example of an optical see-through augmented reality system including a waveguide display according to certain embodiments.

FIG. 5 illustrates an example of an optical see-through augmented reality system including a waveguide display for exit pupil expansion according to certain embodiments.

FIG. 6A illustrates an example of an optical see-through augmented reality system including a waveguide display and surface-relief gratings for exit pupil expansion according to certain embodiments.

FIG. 6B illustrates an example of an eyebox including a two-dimensional array of replicated exit pupils.

FIGS. 7A-7C show that the pupil replication density may depend on the thickness of the waveguide.

FIG. 7D illustrates an example of a waveguide including an embedded beam splitter (e.g., partial reflector) in the waveguide.

FIG. 8A illustrates an example of a waveguide display including one or more groups of reflective and/or transflective mirrors for two-dimensional pupil expansion according to certain embodiments.

FIG. 8B illustrates an example of an eyebox including a two-dimensional array of replicated exit pupils.

FIGS. 9A-9C illustrate examples of a pupil expander in the form of a geometrical waveguide that includes a set of transflective mirrors within the geometrical waveguide.

FIG. 10A illustrates an example of a geometrical waveguide display.

FIG. 10B illustrates an example of pupil replication in the geometrical waveguide display of FIG. 10A.

FIG. 10C illustrates an example of a geometrical waveguide display including an embedded partial reflector parallel to a surface of the geometrical waveguide display.

FIG. 10D illustrates an example of pupil replication in the geometrical waveguide display of FIG. 10C.

FIG. 11A illustrates an example of a geometrical waveguide display including two or more embedded partial reflectors parallel to a surface of the geometrical waveguide display according to certain embodiments.

FIG. 11B illustrates an example of pupil replication in the geometrical waveguide display of FIG. 11A.

FIG. 12A illustrates an example of simulation of pupil replication by a single waveguide.

FIG. 12B illustrates an example of the simulation result showing pupils replicated by the single waveguide.

FIG. 13A illustrates an example of simulation of pupil replication by a stacked waveguide including embedded transflective mirrors parallel to a surface of the stacked waveguide according to certain embodiments.

FIG. 13B illustrates an example of the simulation result showing pupils replicated by the stacked waveguide including embedded transflective mirrors parallel to a surface of the stacked waveguide according to certain embodiments.

FIG. 14 illustrates an example of a geometrical waveguide for one-dimensional pupil replication.

FIG. 15A illustrates an example of a pupil expander including a variable reflectivity transflective mirror on a surface of a waveguide for one-dimensional pupil replication according to certain embodiments.

FIG. 15B illustrates another example of a pupil expander including a variable reflectivity transflective mirror on a surface of a waveguide for one-dimensional pupil replication according to certain embodiments.

FIG. 16A illustrates an example of a waveguide display including two one-dimensional pupil expanders for two-dimensional pupil replication according to certain embodiments.

FIG. 16B illustrates another example of a waveguide display including two one-dimensional pupil expanders for two-dimensional pupil replication according to certain embodiments.

FIG. 17 illustrates another example of a waveguide display including two one-dimensional pupil expanders for two-dimensional pupil replication according to certain embodiments.

FIG. 18 is a simplified block diagram of an electronic system of an example of a near-eye display for implementing some of the examples disclosed herein.

The figures depict embodiments of the present disclosure for purposes of illustration only. One skilled in the art will readily recognize from the following description that alternative embodiments of the structures and methods illustrated may be employed without departing from the principles, or benefits touted, of this disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

This disclosure relates generally to near-eye display systems. More specifically, disclosed herein are pupil expanders for pupil replication in near-eye display systems. Various inventive embodiments are described herein, including devices, components, systems, modules, assemblies, subsystems, and the like.

An optical see-through near-eye display system for augmented reality or mixed reality applications generally includes an image source (e.g., a micro-display), an optical combiner, and an eyepiece. The optical combiner may include, for example, a flat beam splitter, a curved or freeform surface with a beam-splitting coating, a diffractive (e.g., holographic) waveguide, or a geometrical waveguide. Optical combiners made of flat beam splitters or freeform surfaces may have high image quality but may have large sizes. Waveguide displays using, for example, diffractive couplers (e.g., volume Bragg gratings or surface-relief gratings) or transflective mirrors, can be made thin and compact. In waveguide displays, multiple waveguides and/or couplers may be used to replicate the exit pupil, thereby increasing the size of the eyebox so that the user's eyes may be able to view the displayed image even if the user's eyes move within a large area. In some waveguide displays, a 50/50 reflective layer parallel to the waveguide surface may be used to duplicate and mix the pupils, thereby improving the pupil replication density and uniformity in the eyebox. The 50/50 reflective layer may generate a second guided mode within the waveguide, thereby creating a set of exit pupils, in addition to the set of exit pupils replicated from a first guided mode within the waveguide. The set of exit pupils created from the second guided mode may partially overlap with the set of exit pupils created from the first guided mode in the eyebox, and thus the light intensity in the eyebox may not be uniform.

According to certain embodiments, two or more partial reflective mirrors may be used in a waveguide, where the two or more mirrors may be parallel to a surface of the waveguide, and may, in some embodiments, equally spaced in a thickness direction of the waveguide. The two or more partial reflective mirrors may significantly increase the light intensity uniformity of the eyebox, without increasing the number of facets or changing the size of the input (entrance) pupil. The waveguide may be, for example, a grating waveguide that include a grating coupler (e.g., a surface-relief grating or a holographic grating) for pupil replication, or a geometrical waveguide including an array of transflective mirrors for pupil replication.

According to certain embodiments, a one-dimensional pupil expander may include a waveguide transparent to display light and configured to guide the display light along a first direction, a partial reflective mirror on a first surface of the waveguide, and a reflector on a second surface of the waveguide opposing the first surface. The partial reflective mirror may be parallel to the first direction and may be characterized by different reflectivity at a plurality of regions along the first direction. Each region of the plurality of regions of the partial reflective mirror may be configured to partially reflect incident light towards the reflector and partially transmit the incident light through the region of the plurality of regions of the partial reflective mirror. The reflector may be configured to reflect the light reflected by a region of the plurality of regions of the partial reflective mirror towards another region of the plurality of regions of the partial reflective mirror. The reflector may include, for example, a mirror or an interface between the waveguide and air that is configured to cause total internal reflection. In some embodiments, two such one-dimensional pupil expanders may be used in a near-eye display system to replicate the pupil in two directions to form a 2-D array of pupils.

In the following description, for the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples. The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

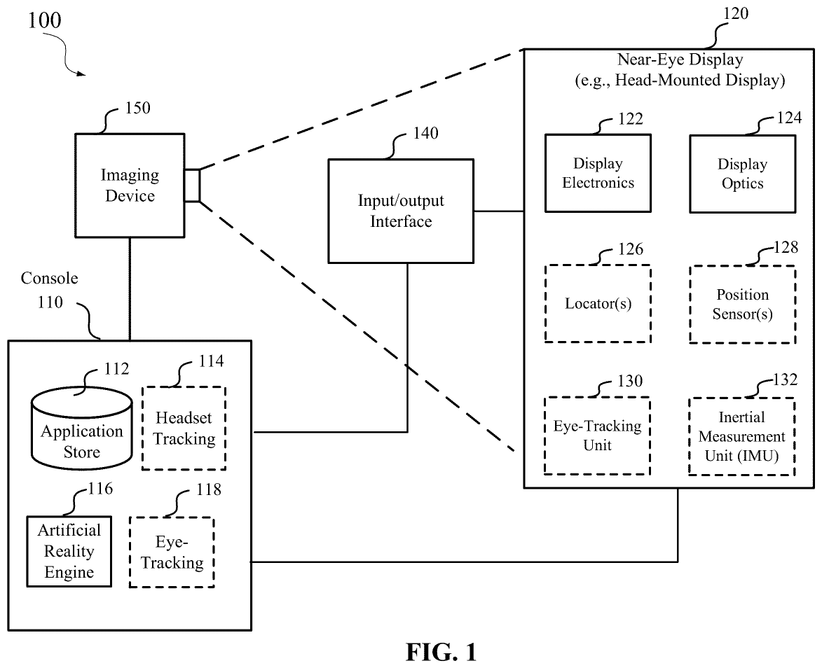

FIG. 1 is a simplified block diagram of an example of an artificial reality system environment 100 including a near-eye display 120 in accordance with certain embodiments. Artificial reality system environment 100 shown in FIG. 1 may include near-eye display 120, an optional external imaging device 150, and an optional input/output interface 140, each of which may be coupled to an optional console 110. While FIG. 1 shows an example of artificial reality system environment 100 including one near-eye display 120, one external imaging device 150, and one input/output interface 140, any number of these components may be included in artificial reality system environment 100, or any of the components may be omitted. For example, there may be multiple near-eye displays 120 monitored by one or more external imaging devices 150 in communication with console 110. In some configurations, artificial reality system environment 100 may not include external imaging device 150, optional input/output interface 140, and optional console 110. In alternative configurations, different or additional components may be included in artificial reality system environment 100.

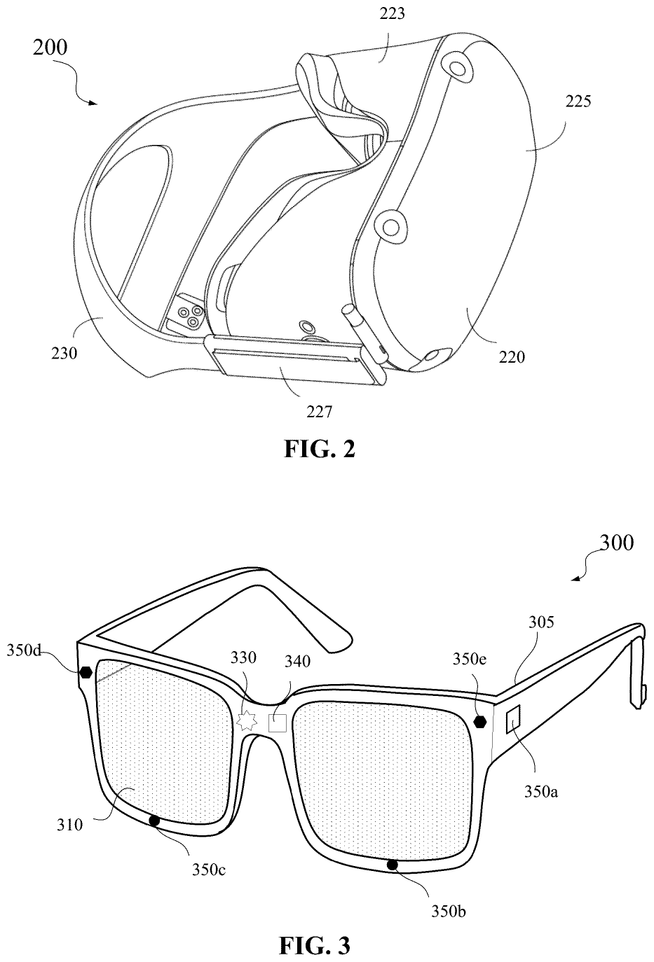

Near-eye display 120 may be a head-mounted display that presents content to a user. Examples of content presented by near-eye display 120 include one or more of images, videos, audio, or any combination thereof. In some embodiments, audio may be presented via an external device (e.g., speakers and/or headphones) that receives audio information from near-eye display 120, console 110, or both, and presents audio data based on the audio information. Near-eye display 120 may include one or more rigid bodies, which may be rigidly or non-rigidly coupled to each other. A rigid coupling between rigid bodies may cause the coupled rigid bodies to act as a single rigid entity. A non-rigid coupling between rigid bodies may allow the rigid bodies to move relative to each other. In various embodiments, near-eye display 120 may be implemented in any suitable form-factor, including a pair of glasses. Some embodiments of near-eye display 120 are further described below with respect to FIGS. 2 and 3. Additionally, in various embodiments, the functionality described herein may be used in a headset that combines images of an environment external to near-eye display 120 and artificial reality content (e.g., computer-generated images). Therefore, near-eye display 120 may augment images of a physical, real-world environment external to near-eye display 120 with generated content (e.g., images, video, sound, etc.) to present an augmented reality to a user.

In various embodiments, near-eye display 120 may include one or more of display electronics 122, display optics 124, and an eye-tracking unit 130. In some embodiments, near-eye display 120 may also include one or more locators 126, one or more position sensors 128, and an inertial measurement unit (IMU) 132. Near-eye display 120 may omit any of eye-tracking unit 130, locators 126, position sensors 128, and IMU 132, or include additional elements in various embodiments. Additionally, in some embodiments, near-eye display 120 may include elements combining the function of various elements described in conjunction with FIG. 1.

Display electronics 122 may display or facilitate the display of images to the user according to data received from, for example, console 110. In various embodiments, display electronics 122 may include one or more display panels, such as a liquid crystal display (LCD), an organic light emitting diode (OLED) display, an inorganic light emitting diode (ILED) display, a micro light emitting diode (μLED) display, an active-matrix OLED display (AMOLED), a transparent OLED display (TOLED), or some other display. For example, in one implementation of near-eye display 120, display electronics 122 may include a front TOLED panel, a rear display panel, and an optical component (e.g., an attenuator, polarizer, or diffractive or spectral film) between the front and rear display panels. Display electronics 122 may include pixels to emit light of a predominant color such as red, green, blue, white, or yellow. In some implementations, display electronics 122 may display a three-dimensional (3D) image through stereoscopic effects produced by two-dimensional panels to create a subjective perception of image depth. For example, display electronics 122 may include a left display and a right display positioned in front of a user's left eye and right eye, respectively. The left and right displays may present copies of an image shifted horizontally relative to each other to create a stereoscopic effect (i.e., a perception of image depth by a user viewing the image).

In certain embodiments, display optics 124 may display image content optically (e.g., using optical waveguides and couplers) or magnify image light received from display electronics 122, correct optical errors associated with the image light, and present the corrected image light to a user of near-eye display 120. In various embodiments, display optics 124 may include one or more optical elements, such as, for example, a substrate, optical waveguides, an aperture, a Fresnel lens, a convex lens, a concave lens, a filter, input/output couplers, or any other suitable optical elements that may affect image light emitted from display electronics 122. Display optics 124 may include a combination of different optical elements as well as mechanical couplings to maintain relative spacing and orientation of the optical elements in the combination. One or more optical elements in display optics 124 may have an optical coating, such as an antireflective coating, a reflective coating, a filtering coating, or a combination of different optical coatings.

Magnification of the image light by display optics 124 may allow display electronics 122 to be physically smaller, weigh less, and consume less power than larger displays. Additionally, magnification may increase a field of view of the displayed content. The amount of magnification of image light by display optics 124 may be changed by adjusting, adding, or removing optical elements from display optics 124. In some embodiments, display optics 124 may project displayed images to one or more image planes that may be further away from the user's eyes than near-eye display 120.

Display optics 124 may also be designed to correct one or more types of optical errors, such as two-dimensional optical errors, three-dimensional optical errors, or any combination thereof. Two-dimensional errors may include optical aberrations that occur in two dimensions. Example types of two-dimensional errors may include barrel distortion, pincushion distortion, longitudinal chromatic aberration, and transverse chromatic aberration. Three-dimensional errors may include optical errors that occur in three dimensions. Example types of three-dimensional errors may include spherical aberration, comatic aberration, field curvature, and astigmatism.

Locators 126 may be objects located in specific positions on near-eye display 120 relative to one another and relative to a reference point on near-eye display 120. In some implementations, console 110 may identify locators 126 in images captured by external imaging device 150 to determine the artificial reality headset's position, orientation, or both. A locator 126 may be a light-emitting diode (LED), a corner cube reflector, a reflective marker, a type of light source that contrasts with an environment in which near-eye display 120 operates, or any combination thereof. In embodiments where locators 126 are active components (e.g., LEDs or other types of light emitting devices), locators 126 may emit light in the visible band (e.g., about 380 nm to 750 nm), in the infrared (IR) band (e.g., about 750 nm to 1 mm), in the ultraviolet band (e.g., about 12 nm to about 380 nm), in another portion of the electromagnetic spectrum, or in any combination of portions of the electromagnetic spectrum.

External imaging device 150 may include one or more cameras, one or more video cameras, any other device capable of capturing images including one or more of locators 126, or any combination thereof. Additionally, external imaging device 150 may include one or more filters (e.g., to increase signal to noise ratio). External imaging device 150 may be configured to detect light emitted or reflected from locators 126 in a field of view of external imaging device 150. In embodiments where locators 126 include passive elements (e.g., retroreflectors), external imaging device 150 may include a light source that illuminates some or all of locators 126, which may retro-reflect the light to the light source in external imaging device 150. Slow calibration data may be communicated from external imaging device 150 to console 110, and external imaging device 150 may receive one or more calibration parameters from console 110 to adjust one or more imaging parameters (e.g., focal length, focus, frame rate, sensor temperature, shutter speed, aperture, etc.).

Position sensors 128 may generate one or more measurement signals in response to motion of near-eye display 120. Examples of position sensors 128 may include accelerometers, gyroscopes, magnetometers, other motion-detecting or error-correcting sensors, or any combination thereof. For example, in some embodiments, position sensors 128 may include multiple accelerometers to measure translational motion (e.g., forward/back, up/down, or left/right) and multiple gyroscopes to measure rotational motion (e.g., pitch, yaw, or roll). In some embodiments, various position sensors may be oriented orthogonally to each other.

IMU 132 may be an electronic device that generates fast calibration data based on measurement signals received from one or more of position sensors 128. Position sensors 128 may be located external to IMU 132, internal to IMU 132, or any combination thereof. Based on the one or more measurement signals from one or more position sensors 128, IMU 132 may generate fast calibration data indicating an estimated position of near-eye display 120 relative to an initial position of near-eye display 120. For example, IMU 132 may integrate measurement signals received from accelerometers over time to estimate a velocity vector and integrate the velocity vector over time to determine an estimated position of a reference point on near-eye display 120. Alternatively, IMU 132 may provide the sampled measurement signals to console 110, which may determine the fast calibration data. While the reference point may generally be defined as a point in space, in various embodiments, the reference point may also be defined as a point within near-eye display 120 (e.g., a center of IMU 132).

Eye-tracking unit 130 may include one or more eye-tracking systems. Eye tracking may refer to determining an eye's position, including orientation and location of the eye, relative to near-eye display 120. An eye-tracking system may include an imaging system to image one or more eyes and may optionally include a light emitter, which may generate light that is directed to an eye such that light reflected by the eye may be captured by the imaging system. For example, eye-tracking unit 130 may include a non-coherent or coherent light source (e.g., a laser diode) emitting light in the visible spectrum or infrared spectrum, and a camera capturing the light reflected by the user's eye. As another example, eye-tracking unit 130 may capture reflected radio waves emitted by a miniature radar unit. Eye-tracking unit 130 may use low-power light emitters that emit light at frequencies and intensities that would not injure the eye or cause physical discomfort. Eye-tracking unit 130 may be arranged to increase contrast in images of an eye captured by eye-tracking unit 130 while reducing the overall power consumed by eye-tracking unit 130 (e.g., reducing power consumed by a light emitter and an imaging system included in eye-tracking unit 130). For example, in some implementations, eye-tracking unit 130 may consume less than 120 milliwatts of power.

Near-eye display 120 may use the orientation of the eye to, e.g., determine an inter-pupillary distance (IPD) of the user, determine gaze direction, introduce depth cues (e.g., blur image outside of the user's main line of sight), collect heuristics on the user interaction in the VR media (e.g., time spent on any particular subject, object, or frame as a function of exposed stimuli), some other functions that are based in part on the orientation of at least one of the user's eyes, or any combination thereof. Because the orientation may be determined for both eyes of the user, eye-tracking unit 130 may be able to determine where the user is looking. For example, determining a direction of a user's gaze may include determining a point of convergence based on the determined orientations of the user's left and right eyes. A point of convergence may be the point where the two foveal axes of the user's eyes intersect. The direction of the user's gaze may be the direction of a line passing through the point of convergence and the mid-point between the pupils of the user's eyes.

Input/output interface 140 may be a device that allows a user to send action requests to console 110. An action request may be a request to perform a particular action. For example, an action request may be to start or to end an application or to perform a particular action within the application. Input/output interface 140 may include one or more input devices. Example input devices may include a keyboard, a mouse, a game controller, a glove, a button, a touch screen, or any other suitable device for receiving action requests and communicating the received action requests to console 110. An action request received by the input/output interface 140 may be communicated to console 110, which may perform an action corresponding to the requested action. In some embodiments, input/output interface 140 may provide haptic feedback to the user in accordance with instructions received from console 110. For example, input/output interface 140 may provide haptic feedback when an action request is received, or when console 110 has performed a requested action and communicates instructions to input/output interface 140. In some embodiments, external imaging device 150 may be used to track input/output interface 140, such as tracking the location or position of a controller (which may include, for example, an IR light source) or a hand of the user to determine the motion of the user. In some embodiments, near-eye display 120 may include one or more imaging devices to track input/output interface 140, such as tracking the location or position of a controller or a hand of the user to determine the motion of the user.

Console 110 may provide content to near-eye display 120 for presentation to the user in accordance with information received from one or more of external imaging device 150, near-eye display 120, and input/output interface 140. In the example shown in FIG. 1, console 110 may include an application store 112, a headset tracking subsystem 114, an artificial reality engine 116, and an eye-tracking subsystem 118. Some embodiments of console 110 may include different or additional devices or subsystems than those described in conjunction with FIG. 1. Functions further described below may be distributed among components of console 110 in a different manner than is described here.

In some embodiments, console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In various embodiments, the devices or subsystems of console 110 described in conjunction with FIG. 1 may be encoded as instructions in the non-transitory computer-readable storage medium that, when executed by the processor, cause the processor to perform the functions further described below.

Application store 112 may store one or more applications for execution by console 110. An application may include a group of instructions that, when executed by a processor, generates content for presentation to the user. Content generated by an application may be in response to inputs received from the user via movement of the user's eyes or inputs received from the input/output interface 140. Examples of the applications may include gaming applications, conferencing applications, video playback application, or other suitable applications.

Headset tracking subsystem 114 may track movements of near-eye display 120 using slow calibration information from external imaging device 150. For example, headset tracking subsystem 114 may determine positions of a reference point of near-eye display 120 using observed locators from the slow calibration information and a model of near-eye display 120. Headset tracking subsystem 114 may also determine positions of a reference point of near-eye display 120 using position information from the fast calibration information. Additionally, in some embodiments, headset tracking subsystem 114 may use portions of the fast calibration information, the slow calibration information, or any combination thereof, to predict a future location of near-eye display 120. Headset tracking subsystem 114 may provide the estimated or predicted future position of near-eye display 120 to artificial reality engine 116.

Artificial reality engine 116 may execute applications within artificial reality system environment 100 and receive position information of near-eye display 120, acceleration information of near-eye display 120, velocity information of near-eye display 120, predicted future positions of near-eye display 120, or any combination thereof from headset tracking subsystem 114. Artificial reality engine 116 may also receive estimated eye position and orientation information from eye-tracking subsystem 118. Based on the received information, artificial reality engine 116 may determine content to provide to near-eye display 120 for presentation to the user. For example, if the received information indicates that the user has looked to the left, artificial reality engine 116 may generate content for near-eye display 120 that mirrors the user's eye movement in a virtual environment. Additionally, artificial reality engine 116 may perform an action within an application executing on console 110 in response to an action request received from input/output interface 140, and provide feedback to the user indicating that the action has been performed. The feedback may be visual or audible feedback via near-eye display 120 or haptic feedback via input/output interface 140.

Eye-tracking subsystem 118 may receive eye-tracking data from eye-tracking unit 130 and determine the position of the user's eye based on the eye tracking data. The position of the eye may include an eye's orientation, location, or both relative to near-eye display 120 or any element thereof. Because the eye's axes of rotation change as a function of the eye's location in its socket, determining the eye's location in its socket may allow eye-tracking subsystem 118 to more accurately determine the eye's orientation.

FIG. 2 is a perspective view of an example of a near-eye display in the form of an HMD device 200 for implementing some of the examples disclosed herein. HMD device 200 may be a part of, e.g., a VR system, an AR system, an MR system, or any combination thereof. HMD device 200 may include a body 220 and a head strap 230. FIG. 2 shows a bottom side 223, a front side 225, and a left side 227 of body 220 in the perspective view. Head strap 230 may have an adjustable or extendible length. There may be a sufficient space between body 220 and head strap 230 of HMD device 200 for allowing a user to mount HMD device 200 onto the user's head. In various embodiments, HMD device 200 may include additional, fewer, or different components. For example, in some embodiments, HMD device 200 may include eyeglass temples and temple tips as shown in, for example, FIG. 3 below, rather than head strap 230.

HMD device 200 may present to a user media including virtual and/or augmented views of a physical, real-world environment with computer-generated elements. Examples of the media presented by HMD device 200 may include images (e.g., two-dimensional (2D) or three-dimensional (3D) images), videos (e.g., 2D or 3D videos), audio, or any combination thereof. The images and videos may be presented to each eye of the user by one or more display assemblies (not shown in FIG. 2) enclosed in body 220 of HMD device 200. In various embodiments, the one or more display assemblies may include a single electronic display panel or multiple electronic display panels (e.g., one display panel for each eye of the user). Examples of the electronic display panel(s) may include, for example, an LCD, an OLED display, an ILED display, a μLED display, an AMOLED, a TOLED, some other display, or any combination thereof. HMD device 200 may include two eyebox regions.

In some implementations, HMD device 200 may include various sensors (not shown), such as depth sensors, motion sensors, position sensors, and eye tracking sensors. Some of these sensors may use a structured light pattern for sensing. In some implementations, HMD device 200 may include an input/output interface for communicating with a console. In some implementations, HMD device 200 may include a virtual reality engine (not shown) that can execute applications within HMD device 200 and receive depth information, position information, acceleration information, velocity information, predicted future positions, or any combination thereof of HMD device 200 from the various sensors. In some implementations, the information received by the virtual reality engine may be used for producing a signal (e.g., display instructions) to the one or more display assemblies. In some implementations, HMD device 200 may include locators (not shown, such as locators 126) located in fixed positions on body 220 relative to one another and relative to a reference point. Each of the locators may emit light that is detectable by an external imaging device.

FIG. 3 is a perspective view of an example of a near-eye display 300 in the form of a pair of glasses for implementing some of the examples disclosed herein. Near-eye display 300 may be a specific implementation of near-eye display 120 of FIG. 1, and may be configured to operate as a virtual reality display, an augmented reality display, and/or a mixed reality display. Near-eye display 300 may include a frame 305 and a display 310. Display 310 may be configured to present content to a user. In some embodiments, display 310 may include display electronics and/or display optics. For example, as described above with respect to near-eye display 120 of FIG. 1, display 310 may include an LCD display panel, an LED display panel, or an optical display panel (e.g., a waveguide display assembly).

Near-eye display 300 may further include various sensors 350a, 350b, 350c, 350d, and 350e on or within frame 305. In some embodiments, sensors 350a-350e may include one or more depth sensors, motion sensors, position sensors, inertial sensors, or ambient light sensors. In some embodiments, sensors 350a-350e may include one or more image sensors configured to generate image data representing different fields of views in different directions. In some embodiments, sensors 350a-350e may be used as input devices to control or influence the displayed content of near-eye display 300, and/or to provide an interactive VR/AR/MR experience to a user of near-eye display 300. In some embodiments, sensors 350a-350e may also be used for stereoscopic imaging.

In some embodiments, near-eye display 300 may further include one or more illuminators 330 to project light into the physical environment. The projected light may be associated with different frequency bands (e.g., visible light, infra-red light, ultra-violet light, etc.), and may serve various purposes. For example, illuminator(s) 330 may project light in a dark environment (or in an environment with low intensity of infra-red light, ultra-violet light, etc.) to assist sensors 350a-350e in capturing images of different objects within the dark environment. In some embodiments, illuminator(s) 330 may be used to project certain light patterns onto the objects within the environment. In some embodiments, illuminator(s) 330 may be used as locators, such as locators 126 described above with respect to FIG. 1.

In some embodiments, near-eye display 300 may also include a high-resolution camera 340. High-resolution camera 340 may capture images of the physical environment in the field of view. The captured images may be processed, for example, by a virtual reality engine (e.g., artificial reality engine 116 of FIG. 1) to add virtual objects to the captured images or modify physical objects in the captured images, and the processed images may be displayed to the user by display 310 for AR or MR applications.

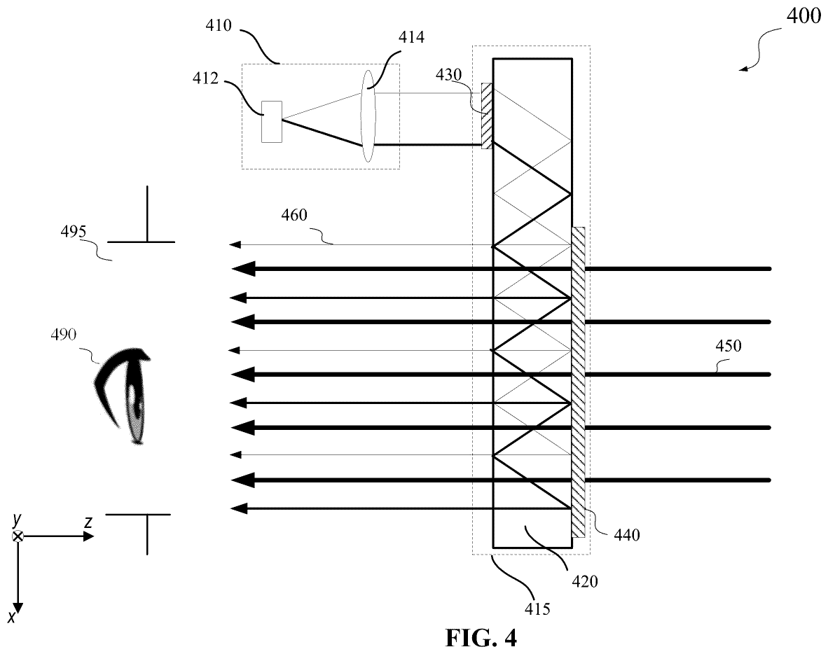

FIG. 4 illustrates an example of an optical see-through augmented reality system 400 including a waveguide display according to certain embodiments. Augmented reality system 400 may include a projector 410 and a combiner 415. Projector 410 may include a light source or image source 412 and projector optics 414. In some embodiments, light source or image source 412 may include one or more micro-LED devices described above. In some embodiments, image source 412 may include a plurality of pixels that displays virtual objects, such as an LCD display panel or an LED display panel. In some embodiments, image source 412 may include a light source that generates coherent or partially coherent light. For example, image source 412 may include a laser diode, a vertical cavity surface emitting laser, an LED, and/or a micro-LED described above. In some embodiments, image source 412 may include a plurality of light sources (e.g., an array of micro-LEDs described above), each emitting a monochromatic image light corresponding to a primary color (e.g., red, green, or blue). In some embodiments, image source 412 may include three two-dimensional arrays of micro-LEDs, where each two-dimensional array of micro-LEDs may include micro-LEDs configured to emit light of a primary color (e.g., red, green, or blue). In some embodiments, image source 412 may include an optical pattern generator, such as a spatial light modulator.

Projector optics 414 may include one or more optical components that can condition the light from image source 412, such as expanding, collimating, scanning, or projecting light from image source 412 to combiner 415. The one or more optical components may include, for example, one or more lenses, liquid lenses, mirrors, apertures, and/or gratings. For example, in some embodiments, image source 412 may include one or more one-dimensional arrays or elongated two-dimensional arrays of micro-LEDs, and projector optics 414 may include one or more one-dimensional scanners (e.g., micro-mirrors or prisms) configured to scan the one-dimensional arrays or elongated two-dimensional arrays of micro-LEDs to generate image frames. In some embodiments, projector optics 414 may include a liquid lens (e.g., a liquid crystal lens) with a plurality of electrodes that allows scanning of the light from image source 412.

Combiner 415 may include an input coupler 430 for coupling light from projector 410 into a substrate 420 of combiner 415. Input coupler 430 may include a volume holographic grating, a diffractive optical element (DOE) (e.g., a surface-relief grating), a slanted surface of substrate 420, or a refractive coupler (e.g., a wedge or a prism). For example, input coupler 430 may include a reflective volume Bragg grating or a transmissive volume Bragg grating. Input coupler 430 may have a coupling efficiency of greater than 30%, 50%, 75%, 90%, or higher for visible light. Light coupled into substrate 420 may propagate within substrate 420 through, for example, total internal reflection (TIR). Substrate 420 may be in the form of a lens of a pair of eyeglasses. Substrate 420 may have a flat or a curved surface, and may include one or more types of dielectric materials, such as glass, quartz, plastic, polymer, poly(methyl methacrylate) (PMMA), crystal, or ceramic. A thickness of the substrate may range from, for example, less than about 1 mm to about 12 mm or more. Substrate 420 may be transparent to visible light.

Substrate 420 may include or may be coupled to a plurality of output couplers 440, each configured to extract at least a portion of the light guided by and propagating within substrate 420 from substrate 420, and direct extracted light 460 to an eyebox 495 where an eye 490 of the user of augmented reality system 400 may be located when augmented reality system 400 is in use. The plurality of output couplers 440 may replicate the exit pupil to increase the size of eyebox 495 such that the displayed image is visible in a larger area. As input coupler 430, output couplers 440 may include grating couplers (e.g., volume holographic gratings or surface-relief gratings), other diffraction optical elements, prisms, etc. For example, output couplers 440 may include reflective volume Bragg gratings or transmissive volume Bragg gratings. Output couplers 440 may have different coupling (e.g., diffraction) efficiencies at different locations. Substrate 420 may also allow light 450 from the environment in front of combiner 415 to pass through with little or no loss. Output couplers 440 may also allow light 450 to pass through with little loss. For example, in some implementations, output couplers 440 may have a very low diffraction efficiency for light 450 such that light 450 may be refracted or otherwise pass through output couplers 440 with little loss, and thus may have a higher intensity than extracted light 460. In some implementations, output couplers 440 may have a high diffraction efficiency for light 450 and may diffract light 450 in certain desired directions (i.e., diffraction angles) with little loss. As a result, the user may be able to view combined images of the environment in front of combiner 415 and images of virtual objects projected by projector 410.

In some embodiments, projector 410, input coupler 430, and output coupler 440 may be on any side of substrate 420. Input coupler 430 and output coupler 440 may be reflective gratings (also referred to as reflective gratings) or transmissive gratings (also referred to as transmissive gratings) to couple display light into or out of substrate 420.

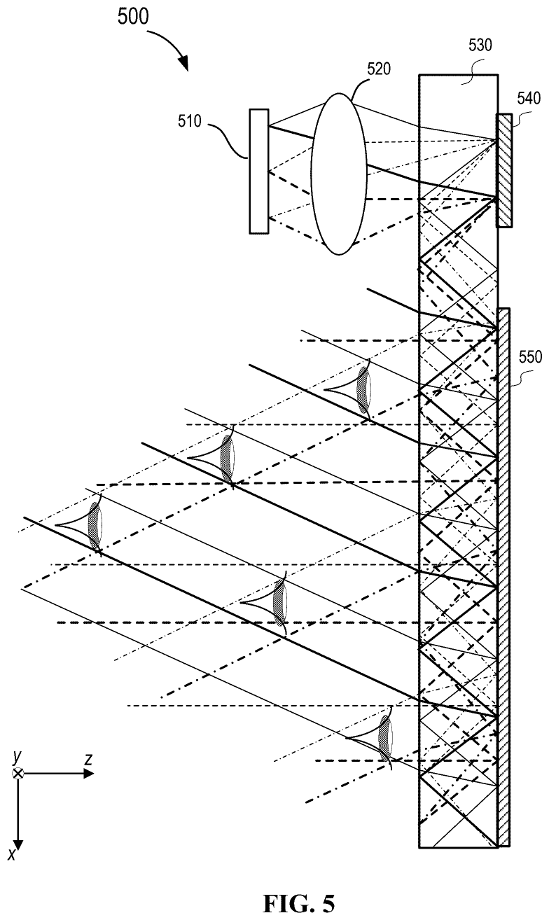

FIG. 5 illustrates an example of an optical see-through augmented reality system 500 including a waveguide display for exit pupil expansion according to certain embodiments. Augmented reality system 500 may be similar to augmented reality system 500, and may include the waveguide display and a projector that may include a light source or image source 510 and projector optics 520. The waveguide display may include a substrate 530, an input coupler 540, and a plurality of output couplers 550 as described above with respect to augmented reality system 500. While FIG. 5 only shows the propagation of light from a single field of view, FIG. 5 shows the propagation of light from multiple fields of view.

FIG. 5 shows that the exit pupil is replicated by output couplers 550 to form an aggregated exit pupil or eyebox, where different regions in a field of view (e.g., different pixels on image source 510) may be associated with different respective propagation directions towards the eyebox, and light from a same field of view (e.g., a same pixel on image source 510) may have a same propagation direction for the different individual exit pupils. Thus, a single image of image source 510 may be formed by the user's eye located anywhere in the eyebox, where light from different individual exit pupils and propagating in the same direction may be from a same pixel on image source 510 and may be focused onto a same location on the retina of the user's eye. In other words, the user's eye may convert angular information in the eyebox or exit pupil (e.g., corresponding to a Fourier plane) to spatial information in images form on the retina. FIG. 5 shows that the image of the image source is visible by the user's eye even if the user's eye moves to different locations in the eyebox.

As described above, in a waveguide-based near-eye display system, light of projected images may be coupled into a waveguide (e.g., a transparent substrate), propagate within the waveguide through total internal reflection, and be coupled out of the waveguide at multiple locations to replicate the exit pupil and expand the eyebox. Multiple waveguides and/or multiple couplers (e.g., gratings or transflective mirrors) may be used to replicate the exit pupil in two dimensions to fill a large eyebox (e.g., 40×40 mm² or larger) with a 2D array of pupils (e.g., 2×2 mm²), thereby expanding the eyebox such that the user's eyes can view the displayed image even if the user's eyes move within a large area. For example, two or more gratings may be used to expand the display light in two dimensions or along two axes. The two gratings may have different grating parameters, such that one grating may be used to replicate the exit pupil in one direction and the other grating may be used to replicate the exit pupil in another direction.

As also described above, in optical see-through near-eye display system for augmented reality or mixed reality applications generally includes an image source (e.g., a micro-display), an optical combiner, and an eyepiece. The optical combiner may include, for example, a flat beam splitter, a curved or freeform surface with a beam-splitting coating, a diffractive (e.g., holographic) waveguide, or a geometrical waveguide. Optical combiners made of flat beam splitters or freeform surfaces may have high image quality but may have large sizes. Waveguide displays using, for example, diffractive couplers (e.g., volume Bragg gratings or surface-relief gratings) or transflective mirrors, can be made thin and compact. In waveguide displays, multiple waveguides and/or couplers may be used to replicate the exit pupil, thereby increasing the size of the eyebox, such that the user's eyes may be able to view the displayed image even if the user's eyes move within a large area.

In a waveguide-based near-eye display system, display light of projected images may be coupled into a waveguide, propagate within the waveguide, and be coupled out of the waveguide at different locations to replicate exit pupils and expand the eyebox. In some implementations of the waveguide-based near eye display system, display light of the projected images may be coupled into or out of a waveguide (e.g., a substrate) using, for example, refractive optical elements (e.g., prisms), diffractive optical elements (e.g., gratings), or partial reflectors (e.g., transflective mirrors). The display light coupled into the waveguide may propagate within the waveguide through total internal reflection at surfaces of the waveguide, and may, for example, be partially diffracted by gratings or reflected by partial reflectors when the display light propagating within the waveguide. The undiffracted or unreflected portion of the display light may continue to propagate within the waveguide through total internal reflection and may be partially diffracted or reflected when the display light reaches another grating or partial reflector. In a waveguide-based near-eye display system for augmented reality applications, light from the surrounding environment may also pass through at least a see-through region of the waveguide display (e.g., a transparent substrate) and reach the eyebox and the user's eyes.

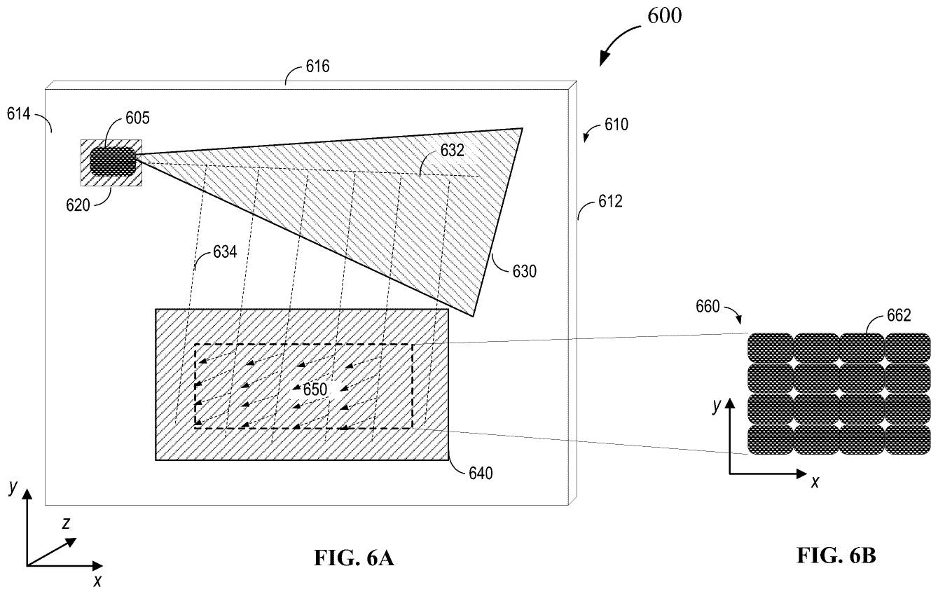

FIG. 6A illustrates an example of an optical see-through augmented reality system including a waveguide display 600 and surface-relief gratings for exit pupil expansion according to certain embodiments. Waveguide display 600 may include a substrate 610 (e.g., a waveguide), which may be similar to substrate 420 or 530. Substrate 610 may be transparent to visible light and may include, for example, a glass, quartz, plastic, polymer, PMMA, ceramic, Si₃N₄, SiC, or crystal substrate. Substrate 610 may be a flat substrate or a curved substrate. Substrate 610 may include two opposing broadside surfaces that include a first surface 612 and a second surface 614, and multiple sidewalls surfaces 616 that may be perpendicular to the broadside surfaces. Display light may be coupled into substrate 610 by an input coupler 620, and may be reflected by first surface 612 and second surface 614 through total internal reflection, such that the display light may propagate within substrate 610. Input coupler 620 may include a grating, a refractive coupler (e.g., a wedge or a prism), or a reflective coupler (e.g., a reflective surface having a slant angle with respect to substrate 610). For example, in one embodiment, input coupler 620 may include a prism that may couple display light of different colors into substrate 610 at a same refraction angle. In another example, input coupler 620 may include a grating coupler that may diffract light of different colors into substrate 610 at different directions. Input coupler 620 may have a coupling efficiency of greater than 10%, 20%, 30%, 50%, 75%, 90%, or higher for visible light.

Waveguide display 600 may also include a first output grating 630 and a second output grating 640 positioned on one or two surfaces (e.g., first surface 612 and second surface 614) of substrate 610 for expanding incident display light beam in two dimensions in order to fill an eyebox with the display light. First output grating 630 may be configured to expand at least a portion of the display light beam along one direction, such as approximately in the x direction. Display light coupled into substrate 610 may propagate in a direction shown by a line 632. While the display light propagates within substrate 610 along a direction shown by line 632, a portion of the display light may be diffracted by a region of first output grating 630 towards second output grating 640 as shown by a line 634 each time the display light propagating within substrate 610 reaches first output grating 630. Second output grating 640 may then expand the display light from first output grating 630 in a different direction (e.g., approximately in the y direction) by diffracting a portion of the display light from an exit region 650 to the eyebox each time the display light propagating within substrate 610 reaches second output grating 640.

FIG. 6B illustrates an example of an eyebox including a two-dimensional array of replicated exit pupils. FIG. 6B shows that a single input pupil 605 may be replicated by first output grating 630 and second output grating 640 to form an aggregated exit pupil 660 that includes a two-dimensional array of individual exit pupils 662. For example, the exit pupil may be replicated in approximately the x direction by first output grating 630 and in approximately the y direction by second output grating 640. As described above, output light from individual exit pupils 662 and propagating in a same direction may be focused onto a same location in the retina of the user's eye. Thus, a single image may be formed by the user's eye from the output light in the two-dimensional array of individual exit pupils 662.

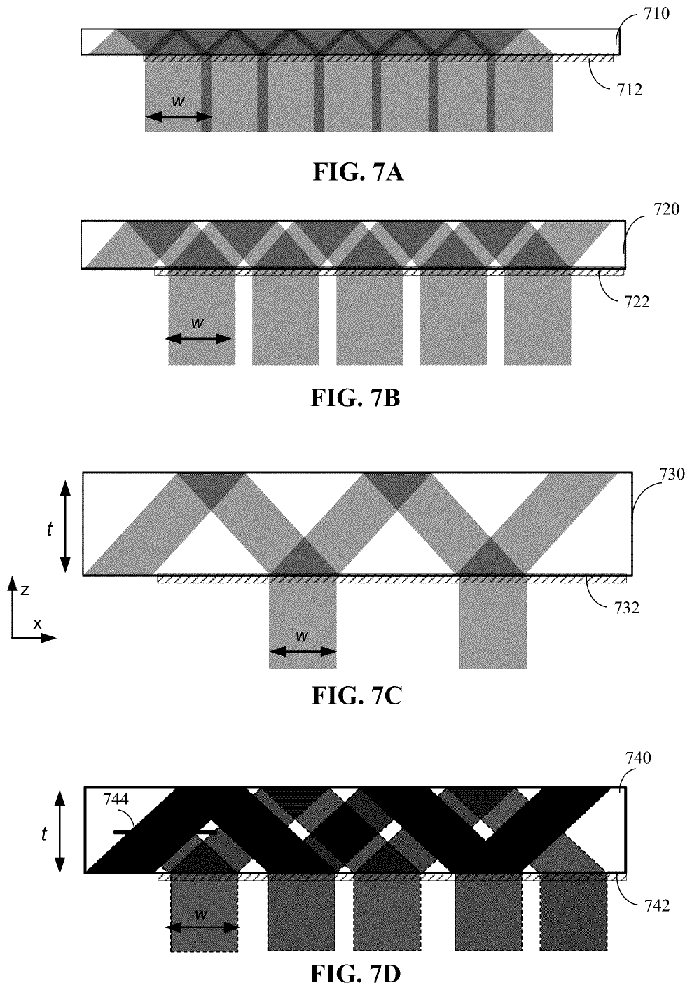

FIGS. 7A-7C show that the pupil replication density may depend on the thickness of the waveguide. In the examples shown in FIGS. 7A-7C, grating couplers 712, 722, and 732 (e.g., surface-relief gratings, holographic gratings, polarization volume holograms, etc.) may be used to couple portions of the guided light out of waveguides 710, 720, and 730, respectively, at a plurality of locations along one direction (e.g., the x direction), thereby replicating the pupils in one direction. As illustrated, for an input beam with the same beam size w, a thin waveguide 710 may replicate the light beam at a high density in at least the light propagation direction (e.g., x direction), a waveguide 720 with a higher thickness (in the z direction) may replicate the light beam at a lower pupil replication density, and a waveguide 730 with an even higher thickness y (in the z direction) may replicate the light beam at a much lower pupil replication density.

FIG. 7D shows an example of a waveguide including an embedded beam splitter (e.g., a 50/50 reflector) in the waveguide to increase the pupil replication density. In the example shown in FIG. 7D, a grating coupler 742 may be used to couple portions of the guided light out of a waveguide 740 at a plurality of locations along one direction (e.g., the x direction), thereby replicating the pupils in one direction. FIG. 7D shows that for a waveguide 740 with a thickness t, when a beam splitter 744 is positioned in the middle (in the thickness direction such as z direction) of waveguide 740, waveguide 740 may replicate the light beam at a higher pupil replication density for an input light beam with a beam width w, such as about two times of the pupil replication density in waveguide 730.

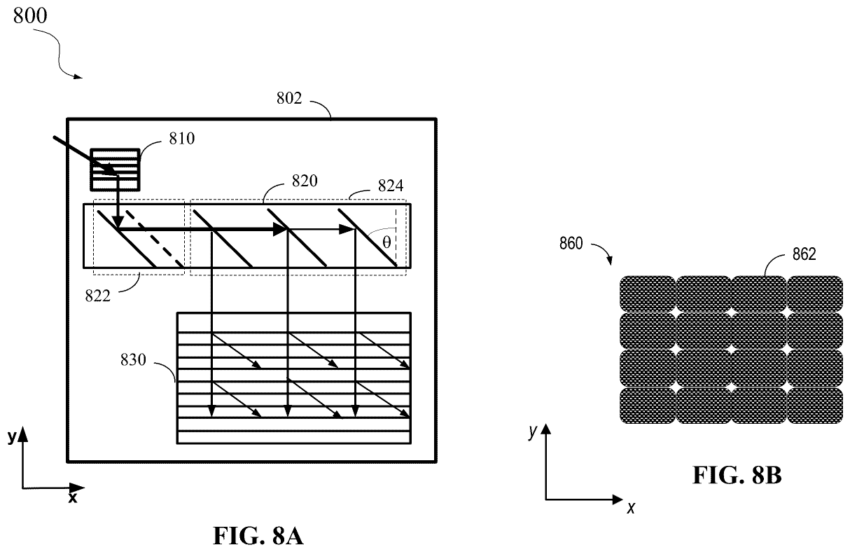

FIG. 8A illustrates an example of a waveguide display 800 including one or more groups of reflective and/or transflective mirrors for two-dimensional pupil expansion according to certain embodiments. Waveguide display 800 may be similar to waveguide display 600, but may use reflective or transflective mirrors (rather than refractive or diffractive optical components) to replace input coupler 620, first output grating 630, and second output grating 640. In the example illustrated in FIG. 8A, waveguide display 800 may include an input coupler 810 that may include one or more reflective and/or transflective mirrors and may be referred to as the input mirror. The input mirror may be used to couple display light into a waveguide 802 such that the display light may propagate within waveguide 802 through total internal reflection. In some embodiments, input coupler 810 may be a prism or a grating.

Waveguide display 800 may include a middle mirror 820 that may include a group of reflective and/or transflective mirrors having the same orientation. One or more reflective and/or transflective mirrors of middle mirror 820 may be used to direct display light from input coupler 810 towards other reflective and/or transflective mirrors of middle mirror 820, which may replicate the pupil in a first dimension (e.g., approximately the x direction) by reflecting portions of the display light at multiple locations along the first dimension as shown in FIG. 8A. For example, a first mirror and a last mirror (e.g., in x direction) in middle mirror 820 may be reflective mirrors with reflectivity close to 100%, and mirrors between the first mirror and the last mirror in middle mirror 820 may be transflective mirrors that have reflectivity less than 100% and are partially transmissive.

In some embodiments, middle mirror 820 may include a first middle mirror 822 and a second middle mirror 824. First middle mirror 822 may include one or more reflective and/or transflective mirrors that may direct display light from input coupler 810 towards second middle mirror 824. For example, the first mirror (e.g., in x direction) in first middle mirror 822 may be a reflective mirror with reflectivity close to 100% and other mirrors in first middle mirror 822 may be transflective mirrors that are partially transmissive. Second middle mirror 824 may include a plurality of reflective and/or transflective mirrors and may expand the pupil in a first dimension (e.g., approximately the x direction) by reflecting portions of the display light at multiple locations along the first dimension as shown in FIG. 8A. In one example, the last mirror (e.g., in x direction) in second middle mirror 824 may be a reflective mirror with reflectivity close to 100%, and other mirrors in second middle mirror 824 may be transflective mirrors that are partially transmissive.

Waveguide display 800 may also include an output mirror 830, which may include a plurality of reflective and/or transflective mirrors. As described above with respect to FIG. 6A and 6B and shown in FIG. 8A, the transflective mirrors in output mirror 830 may reflect, at multiple locations along a second dimension (e.g., approximately the y direction), portions of the display light from each location of the multiple locations of middle mirror 820 to the eyebox to replicate the exit pupil in the second dimension. Therefore, middle mirror 820 and output mirror 830 may replicate the pupil in two-dimensions to fill the eyebox. In one example, the last mirror (e.g., in −y direction) in output mirror 830 may be a reflective mirror with reflectivity close to 100%, and other mirrors in output mirror 830 may be transflective mirrors that are partially transmissive.

FIG. 8B illustrates an example of an eyebox including a two-dimensional array of replicated exit pupils. FIG. 8B shows that a single input pupil may be replicated by middle mirror 820 and output mirror 830 to form an aggregated exit pupil 860 that includes a two-dimensional array of individual exit pupils 862. For example, the exit pupil may be replicated in approximately the x direction by middle mirror 820 and in approximately the y direction by output mirror 830. As described above, output light from individual exit pupils 862 and propagating in a same direction may be focused onto a same location in the retina of the user's eye. Thus, a single image may be formed by the user's eye from the output light in the two-dimensional array of individual exit pupils 862.

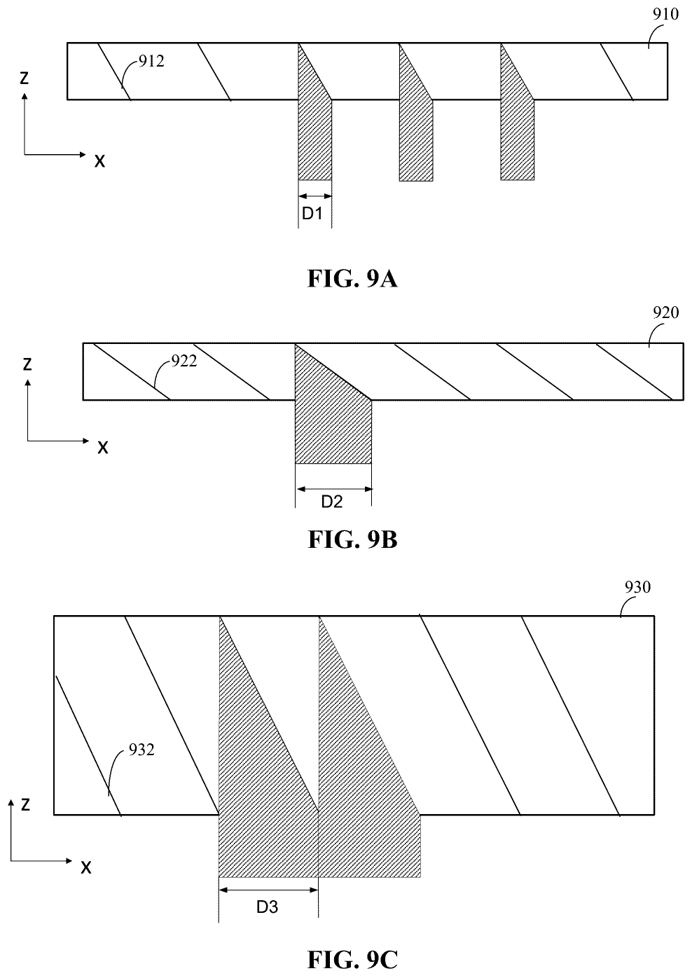

FIG. 9A illustrates an example of a pupil expander in the form of a geometrical waveguide 910 that includes a set of transflective mirrors 912 within geometrical waveguide 910. In the illustrated example, the angle between transflective mirrors 912 and broadside surfaces (e.g., x-y planes) of geometrical waveguide 910 may be large, and thus the diameter D1 of the reflected beam (measured in the x direction) may be small. As such, the modulation transfer function (MTF) of the pupil expander may be low, and the resolution and/or the contrast of the images displayed to the user's eye may be low. In addition, as shown in FIG. 9A, due to the small size of each replicated pupil, there may be gaps between the replicated pupils. As such, the pupil replication density may be low, and the replicated pupils may not fill the eyebox. Therefore, the image uniformity in the eyebox may be low.

FIG. 9B illustrates another example of a pupil expander in the form of a geometrical waveguide 920 that includes a set of transflective mirrors 922 within geometrical waveguide 920. In the illustrated example, the angle between transflective mirrors 922 and the out-coupling surface of geometrical waveguide 920 may be small, and thus the diameter D2 of the reflected beam (measured in the x direction) may be large. As such, the MTF of the pupil expander may be higher, the resolution and/or the contrast of the images displayed to the user's eye may be better, and the replicated pupils may more uniformly fill the eyebox.

FIG. 9C illustrates an example of a pupil expander in the form of a geometrical waveguide 930 that includes a set of transflective mirrors 932 within geometrical waveguide 930. In the illustrated example, the angle between transflective mirrors 932 and the out-coupling surface of geometrical waveguide 930 may be large. But the thickness (in z direction) may be much higher than that of geometrical waveguide 910. As such, the diameter D3 of the reflected beam (measured in the x direction) may be large. Therefore, the MTF of the pupil expander may be higher, the resolution and/or the contrast of the images displayed to the user's eye may be better, and the replicated pupils may more uniformly fill the eyebox. However, increasing the thickness of the geometrical waveguide as shown in FIG. 9C may significantly increase the size and weight of the waveguide display.

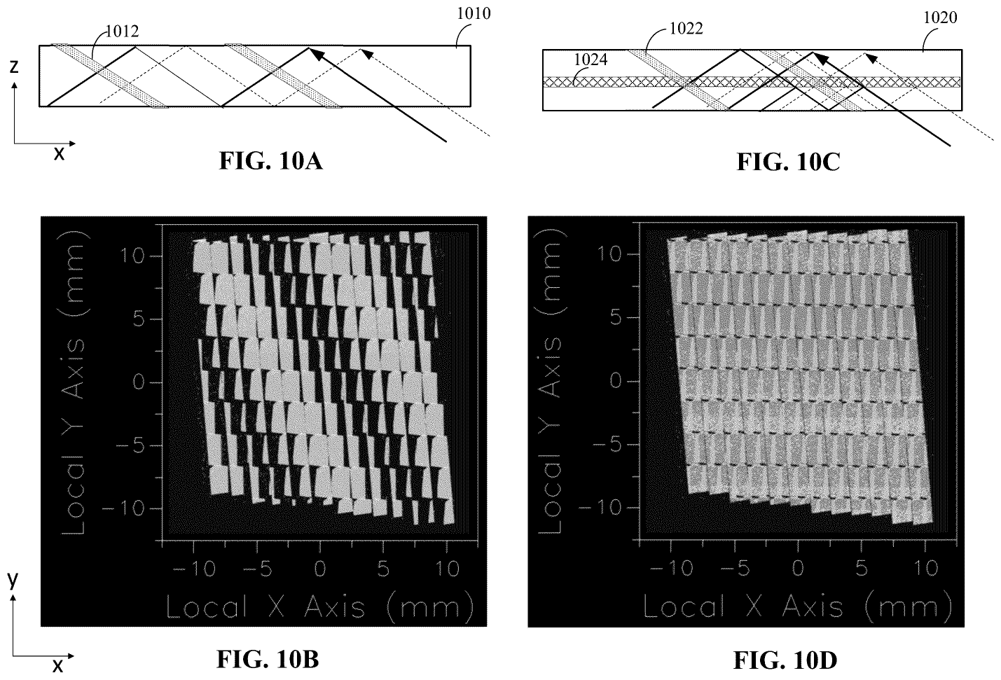

FIG. 10A illustrates an example of a geometrical waveguide display 1010 including transflective mirrors 1012 slanted with respect to surfaces of geometrical waveguide display 1010. As described above, each transflective mirror 1012 may reflect a portion of the incident light out of geometrical waveguide display 1010 and may allow a portion of the incident light to pass though. Thus, transflective mirrors 1012 at different locations of the geometrical waveguide may couple portions of the light propagating in geometrical waveguide display 1020 out of geometrical waveguide display 1020 at different locations, thereby replicating the pupils in the eyebox. Even though only one geometrical waveguide is shown in FIG. 10A, geometrical waveguide display 1010 may include two geometrical waveguides configured to replicate the pupil in two directions to form a 2-D array of exit pupils.

As described above, in order to generate replicated exit pupils with more uniform light intensity, transflective mirrors 1012 at different locations may need to have different reflectivity. For example, the reflectivity of transflective mirrors 1012 may need to gradually increase along the light propagation direction, where the transflective mirror closest to the input coupler may have the lowest reflectivity, while the last transflective mirror on the optical path may have a reflectivity close to about 100%.

FIG. 10B illustrates an example of pupil replication in the geometrical waveguide display 1010 of FIG. 10A. As shown in FIG. 10B, in geometrical waveguide display 1010, there may be gaps between the replicated pupils in the eyebox. Therefore, the replicated pupils may not fill the eyebox and the light intensity in the eyebox may not be uniform.

FIG. 10C illustrates an example of a geometrical waveguide display 1020 including an embedded partial reflector 1024 parallel to a surface of the geometrical waveguide display. As geometrical waveguide display 1010, geometrical waveguide display 1020 may include transflective mirrors 1022 slanted with respect to surfaces of geometrical waveguide display 1020. Geometrical waveguide display 1020 may also include partial reflector 1024 that may partially reflect the guided light (e.g., with a reflectivity about 50%). Geometrical waveguide display 1020 may be formed by bonding two substrates together, where partial reflector 1024 may be formed on a surface of one of the two substrates before bonding.

As illustrated in FIG. 10C, light propagating within geometrical waveguide display 1020 may be split by partial reflector 1024 while propagating from one surface of geometrical waveguide display 1020 to an opposing surface of geometrical waveguide display 1020. One portion of the light may be reflected by partial reflector 1024 back to a surface of geometrical waveguide display 1020 and then reflected at the surface by total internal reflection. The other portion of the light may be transmitted through partial reflector 1024 towards an opposing surface and then reflected by the opposing surface of geometrical waveguide display 1020. In this way, light propagating within geometrical waveguide display 1020 may reach transflective mirrors 1022 more frequently, and thus the pupil may be replicated more frequently and densely to more uniformly fill the eyebox. Even though only one geometrical waveguide is shown in FIG. 10C, geometrical waveguide display 1020 may include two geometrical waveguides configured to replicate the pupil in two directions to form a 2-D array of exit pupils.

FIG. 10D illustrates an example of pupil replication in the geometrical waveguide display 1020 of FIG. 10C. As shown in FIG. 10D, in geometrical waveguide display 1020, the replicated pupils may fill the eyebox more densely, and the light intensity in the eyebox may be more uniform than the example shown in FIG. 10B. However, as shown in FIG. 10D, the replicated exit pupils may partially overlap in some regions, where the regions with overlapped pupils may have higher light intensity than other regions, and thus the light intensity in the eyebox may still not be uniform.

According to certain embodiments, two or more partial reflective mirrors may be used in a waveguide, where the two or more mirrors may be parallel to a surface of the waveguide, and may, in some embodiments, equally spaced in a thickness direction of the waveguide. The two or more partial reflective mirrors may significantly increase the light intensity uniformity of the eyebox, without increasing the number of facets or changing the size of the input (entrance) pupil. The waveguide may be, for example, a grating waveguide that include a grating coupler (e.g., a surface-relief grating or a holographic grating) for pupil replication, or a geometrical waveguide including an array of transflective mirrors for pupil replication.

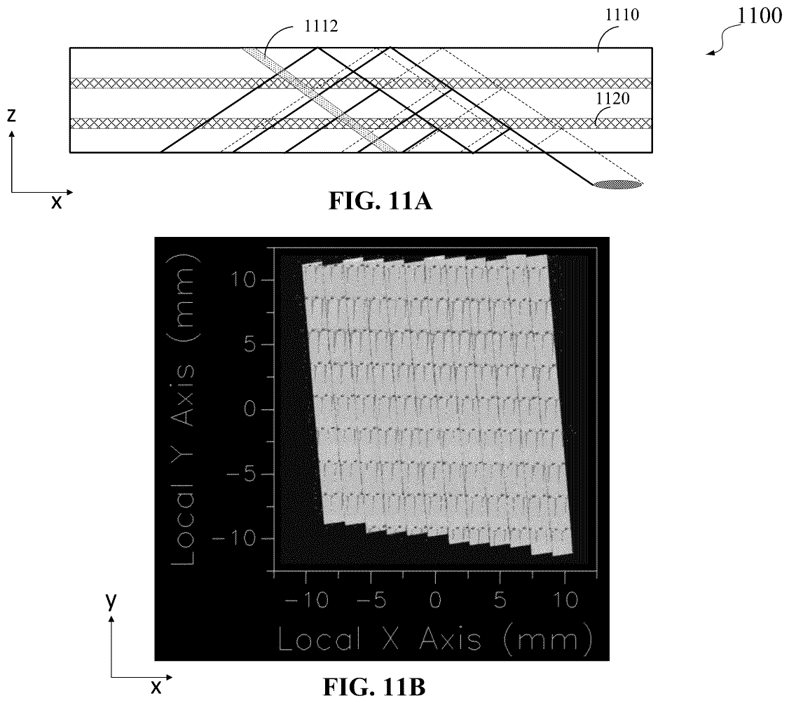

FIG. 11A illustrates an example of a geometrical waveguide display 1100 including two or more embedded partial reflectors 1120 parallel to a surface of a geometrical waveguide 1110 according to certain embodiments. Geometrical waveguide 1110 may include transflective mirrors 1112 at a slant angle with respect to surfaces of geometrical waveguide 1110. Geometrical waveguide 1110 may also include two or more partial reflectors 1120 that may partially reflect the guided light (e.g., with a reflectivity about 50%). The two or more partial reflectors 1120 may be parallel to a surface of geometrical waveguide 1110, and may be evenly or unevenly distributed within geometrical waveguide 1110 in the thickness direction (e.g., z direction). Geometrical waveguide 1110 may be formed by bonding three substrates together, where each partial reflector 1120 may be formed on a surface of a substrate of the three substrates before bonding.

As illustrated in FIG. 11A, light propagating within geometrical waveguide 1110 may be split by partial reflectors 1120 while propagating from one surface of geometrical waveguide 1110 to an opposing surface of geometrical waveguide 1110, where one portion of the light may be reflected by a partial reflector 1120 back towards a surface of geometrical waveguide 1110, while the other portion of the light may be transmitted through partial reflector 1120 towards the opposing surface of geometrical waveguide 1110. In this way, light propagating within geometrical waveguide 1110 may reach transflective mirrors 1112 more frequently, and thus the pupils may be replicated more frequently and densely to fill the eyebox. The replicated pupils may overlap and mix in the eyebox, such that the light intensity in the eyebox may be more uniform. Even though only one geometrical waveguide 1110 is shown in FIG. 11A, geometrical waveguide display 1100 may include two geometrical waveguides configured to replicate the pupil in two directions to form a 2-D array of exit pupils.

FIG. 11B illustrates an example of pupil replication in geometrical waveguide display 1100 of FIG. 11A. As illustrated, the replicated pupils may fill the eyebox even more densely, and the replicated pupils may overlap throughout the eyebox and mix together to achieve more uniform light intensity in the eyebox.

In some embodiments, a surface-relief grating, a holographic grating, a polarization volume hologram, or an array of micro-mirrors formed at a surface of the first waveguide, may be used instead of transflective mirrors 1112 to couple the light out of a waveguide at a plurality of locations.

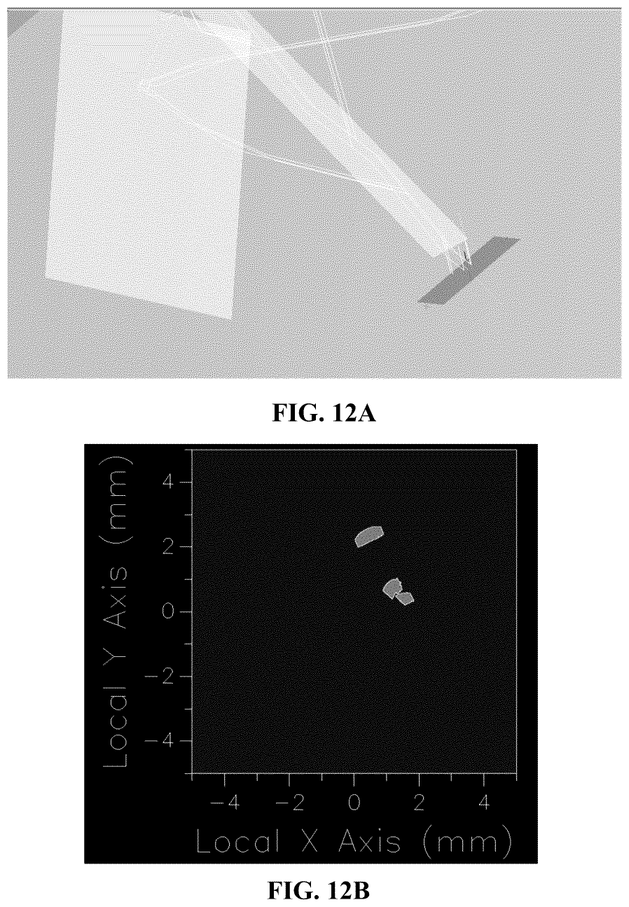

FIG. 12A illustrates an example of simulating the pupil replication by a single waveguide using, for example, ray tracing. FIG. 12B illustrates an example of the simulation result showing pupils replicated by the single waveguide, where the pupil replication density may be low.

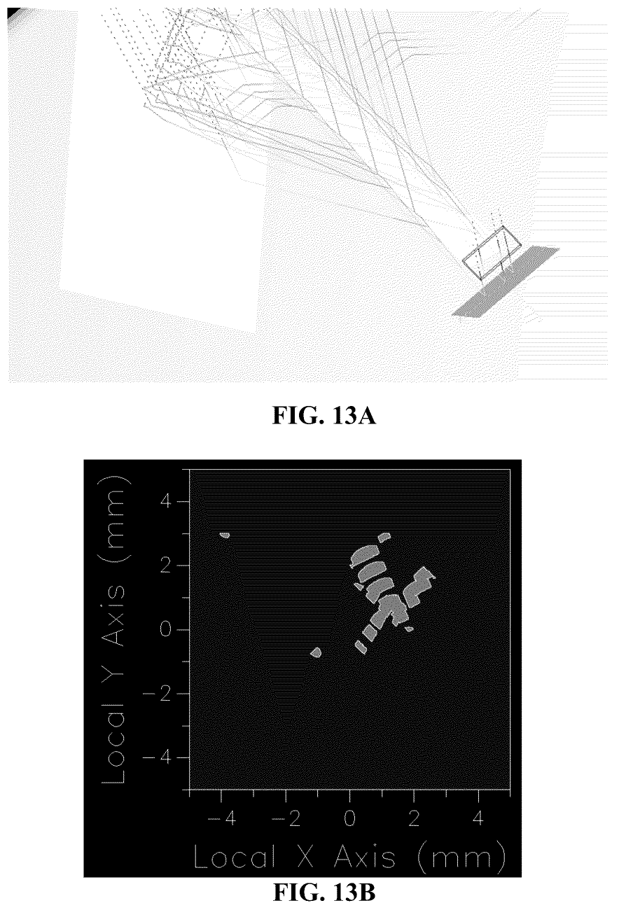

FIG. 13A illustrates an example of simulating the pupil replication by a stacked waveguide including embedded transflective mirrors parallel to a surface of the waveguide according to certain embodiments. FIG. 13B illustrates an example of the simulation result showing pupils replicated by the stacked waveguide including embedded transflective mirrors parallel to a surface of the waveguide according to certain embodiments, where the pupil replication density may be higher.

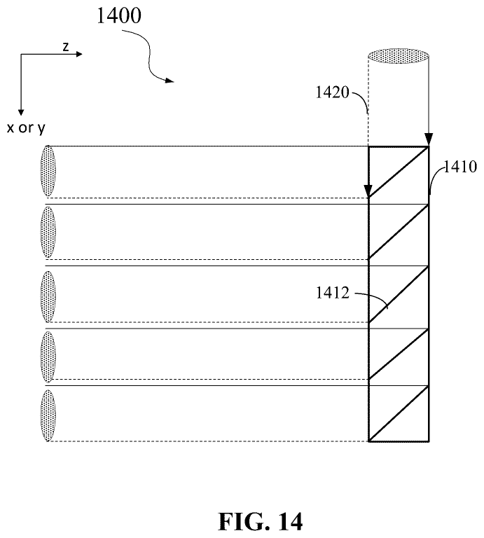

FIG. 14 illustrates an example of a geometrical waveguide 1400 for one-dimensional pupil replication according to certain embodiments. Geometrical waveguide 1400 may include a waveguide 1410 and transflective mirrors 1412 (partial reflectors) in waveguide 1410. Each transflective mirror 1412 may split the incident light by partially reflecting the incident light and partially transmitting the incident light such that a portion of the incident light may continue to propagate within the waveguide to be split by other transflective mirrors. Each transflective mirror 1412 may include, for example, a plurality of dielectric coating layers, one or more metal coating layers, or a combination of dielectric coating layers and metal coating layers.

For example, a transflective mirror may include a plurality of dielectric coating layers coated on a substrate, where the plurality of dielectric coating layers may include two or more different transparent dielectric materials having different refractive indices. The number of dielectric coating layers, and the refractive index and the thickness of each dielectric coating layer may be selected to achieve the desired performance, such as the desired reflectivity (reflection efficiency) and polarization performance. A plurality of substrates with a plurality of transflective mirrors formed thereon may be stacked and bonded (e.g., glued) together using, for example, optically clear adhesives. The bonded stack may be cut at a certain angle to form a geometrical waveguide including a plurality of transflective mirrors embedded therein. Different transflective mirrors in the plurality of transflective mirrors may have different reflectivity efficiencies. For example, the reflectivity of a first transflective mirror that may receive the in-coupled display light before a second transflective mirror may have a lower reflectivity than the second transflective mirror, such that the portion of the display light reflected by the first transflective mirror may have a similar intensity as the portion of the display light reflected by the second transflective mirror.

As illustrated, an input beam 1420 may be split by a first transflective mirror of the array of transflective mirrors, where a fraction of input beam 1420 may be reflected and the other portion of input beam 1420 may be transmitted to reach a second transflective mirror of the array of transflective mirrors. The second transflective mirror and other transflective mirrors may split the incident light beam in a similar manner until the light beam reaches the last transflective mirror in the array of transflective mirrors. The last transflective mirror in the array of transflective mirrors may have a reflectivity about 100% to reflect all incident light. In this way, the input (or entrance) pupil may be replicated along one dimension (e.g., x or y direction in the illustrated example) by an array of transflective mirrors.

In geometrical waveguides such as geometrical waveguides 910, 920, 930, 1110, and 1400 described above, an array of transflective mirrors 1412 embedded in a waveguide is generally used to replicate or expand the pupil in one dimension. As described above, fabricating geometrical waveguides with embedded transflective mirrors may be a complicate and costly process.

According to certain embodiments, a one-dimensional pupil expander may include a waveguide transparent to display light and configured to guide the display light along a first direction, a partial reflective mirror on a first surface of the waveguide, and a reflector on a second surface of the waveguide opposing the first surface. The partial reflective mirror may be parallel to the first direction and may be characterized by different reflectivity at a plurality of regions along the first direction. Each region of the plurality of regions of the partial reflective mirror may be configured to partially reflect incident light towards the reflector and partially transmit the incident light through the region of the plurality of regions of the partial reflective mirror to create of replica of the pupil. The reflector may be configured to reflect the light reflected by a region of the plurality of regions of the partial reflective mirror towards another region of the plurality of regions of the partial reflective mirror. In this way, a plurality of replicas of the pupil may be created by the plurality of regions of the partial reflective mirror. The reflector may include, for example, a mirror (with a reflective close to 100%) or an interface between the waveguide and air that may be configured to cause total internal reflection. In some embodiments, two such one-dimensional pupil expanders may be used in a near-eye display system to replicate the pupil in two directions to form a 2-D array of pupils.

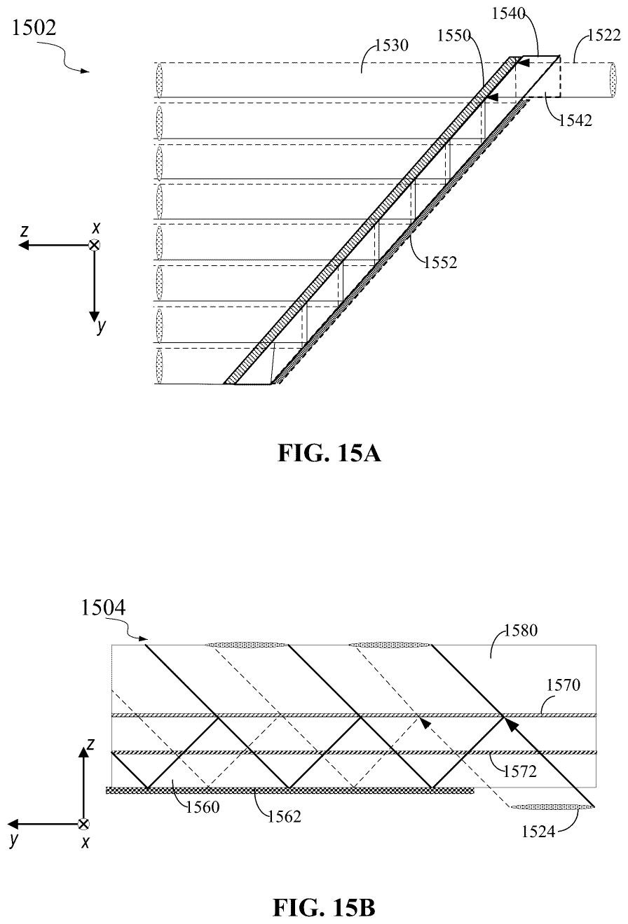

FIG. 15A illustrates an example of a pupil expander 1502 including a variable reflectivity transflective mirror on a surface of a waveguide for one-dimensional pupil replication according to certain embodiments. In the illustrated example, pupil expander 1502 may include a waveguide 1540 (e.g., a bar or a rod), and a variable reflectivity transflective mirror 1550 at an interface between waveguide 1540 and a medium 1530 (e.g., a substrate or air). Variable reflectivity transflective mirror 1550 may be formed on a surface of waveguide 1540 or medium 1530.

As illustrated, an input beam 1522 may be coupled into waveguide 1540 (e.g., by a prism 1542). Input beam 1522 may be partially reflected by a first region of transflective mirror 1550 and partially transmitted by the first region of transflective mirror 1550 into medium 1530. The reflected portion of the input beam may be reflected by a surface of waveguide 1540 opposing transflective mirror 1550, for example, through total internal reflection (or by an optional mirror 1552 that has a reflectivity close to 100% if the total internal reflection condition is not met), towards a second region of transflective mirror 1550. The second region of transflective mirror 1550 may split the incident light by reflecting a portion of the incident light and transmitting a fraction of the incident light into medium 1530, where the reflected portion may be reflected back towards a third region of transflective mirror 1550 by a surface of waveguide 1540 opposing transflective mirror 1550 (or by mirror 1552). In this way, the light coupled into waveguide 1540 may be guided by transflective mirror 1550 and a surface of waveguide 1540 (or mirror 1552) to propagate within waveguide 1540, where portions of the light beam may be transmitted by transflective mirror 1550 into medium 1530 each time the light beam is incident on transflective mirror 1550, thereby replicating the input pupil in one dimension (e.g., the y direction). The period of the pupil replicas may depend on the size and orientation of the waveguide 1540. To achieve more uniform light intensity among the replicated pupils, the reflectivity of transflective mirror 1550 may gradually decrease (or the transmissivity of transflective mirror 1550 may gradually increase) in the direction of light propagation in waveguide 1540, such that the transmissivity of transflective mirror 1550 is lower when the incident light has a higher intensity, and is higher when the incident light has a lower intensity. In some implementations, transflective mirror 1550 may have different reflectivity in different regions. In some implementations, the reflectivity of transflective mirror 1550 may vary (e.g., increase or decrease) continuously along at least one direction (e.g., when each region having a uniform reflectivity is small).

In the example shown in FIG. 15A, if input beam 1522 includes a linear array of replicated pupils (e.g., replicated along the x direction), pupil expander 1502 may further replicate the pupils along another direction (e.g., the y direction), such that output beams of pupil expander 1502 may include a two-dimensional array of pupils replicated along both x and y directions. The linear array of replicated pupils may be generated by another pupil expander disclosed herein, such as another pupil expander 1502.

FIG. 15B illustrates another example of a pupil expander 1504 including a variable reflectivity transflective mirror on a surface of a waveguide for one-dimensional pupil replication according to certain embodiments. In the illustrated example, pupil expander 1504 may include a waveguide 1560, and a variable reflectivity transflective mirror 1570 at an interface between waveguide 1560 and a medium 1580 (e.g., a substrate or air). Variable reflectivity transflective mirror 1570 may be formed on a surface of waveguide 1560 or medium 1580.

As illustrated, an input beam 1524 may be coupled into waveguide 1560 (e.g., by a refractive, diffractive, or reflective coupler). Input beam 1524 may be partially reflected by a first region of transflective mirror 1570 and partially transmitted by the first region of transflective mirror 1570 into medium 1580. The reflected portion of the input beam may be reflected by a surface of waveguide 1560 opposing transflective mirror 1570, for example, through total internal reflection (or by an optional mirror 1562 that has a reflectivity close to 100% if the total internal reflection condition is not met), towards a second region of transflective mirror 1570. The second region of transflective mirror 1570 may split the incident light by reflecting a portion of the incident light and transmitting a fraction of the incident light into medium 1580, where the reflected portion may be reflected back towards a third region of transflective mirror 1570 by a surface of waveguide 1560 opposing transflective mirror 1570 (or by mirror 1562). In this way, the light coupled into waveguide 1560 may be guided by transflective mirror 1570 and a surface of waveguide 1560 (or mirror 1562) to propagate within waveguide 1560, where portions of the light beam may be transmitted by transflective mirror 1570 into medium 1580 each time the light beam is incident on transflective mirror 1570, thereby replicating the input pupil in one dimension (e.g., the y direction). The period of the pupil replicas may depend on the size and orientation of the waveguide 1560. To achieve more uniform light intensity among the replicated pupils, the reflectivity of transflective mirror 1570 may gradually decrease (or the transmissivity of transflective mirror 1570 may gradually increase) in the direction of light propagation in waveguide 1560, such that the transmissivity of transflective mirror 1570 is lower when the incident light has a higher intensity, and is higher when the incident light has a lower intensity. In some implementations, transflective mirror 1570 may have different reflectivity in different regions. In some implementations, the reflectivity of transflective mirror 1570 may vary (e.g., increase or decrease) continuously along at least one direction (e.g., when each region having a uniform reflectivity is small).

In the example shown in FIG. 15B, if input beam 1524 includes a linear array of replicated pupils (e.g., replicated along the x direction), pupil expander 1504 may further replicate the pupils along another direction (e.g., the y direction), such that output beams of pupil expander 1504 may include a two-dimensional array of pupils replicated along both x and y directions. The linear array of replicated pupils may be generated by another pupil expander disclosed herein, such as another pupil expander 1502 or 1504.

As described above, in some embodiments, one or more transflective mirrors 1572 that are parallel to a surface of waveguide 1540 or 1560 may be embedded in waveguide 1540 or 1560 to increase the pupil replication density.

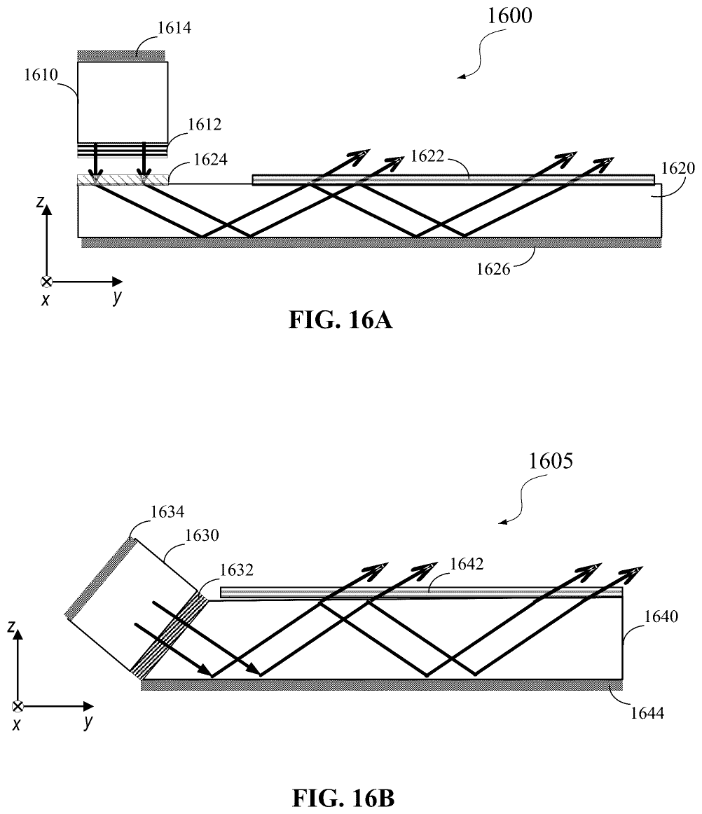

FIG. 16A illustrates an example of a waveguide display 1600 including two one-dimensional pupil expanders 1610 and 1620 for two-dimensional pupil replication according to certain embodiments. Each of pupil expanders 1610 and 1620 may be similar to pupil expander 1502 or pupil expander 1504. Pupil expander 1610 may include a waveguide, a variable reflectivity transflective mirror 1612 (e.g., similar to variable reflectivity transflective mirror 1550) on a surface of the waveguide, and an optional reflector 1614 (e.g., similar to mirror 1552) on an opposing surface of the waveguide. Pupil expander 1610 may replicate the pupil through a plurality of regions of variable reflectivity transflective mirror 1612 along approximately the x direction, as described above with respect to, for example, FIGS. 15A and 15B. Light coupled out of pupil expander 1610 may be coupled into pupil expander 1620 through a coupler 1624, which may be a grating, a prism, or a mirror. Pupil expander 1620 may include a waveguide, a variable reflectivity transflective mirror 1622 (e.g., similar to variable reflectivity transflective mirror 1550) or a grating coupler on a surface of the waveguide, and an optional reflector 1626 (e.g., similar to mirror 1552) on an opposing surface of the waveguide. Pupil expander 1620 may replicate the pupil through a plurality of regions of variable reflectivity transflective mirror 1622 along approximately the y direction, as described above with respect to, for example, FIGS. 15A and 15B. Thus, pupil expanders 1610 and 1620 may replicate the pupil along the x and y directions, respectively, to create a two-dimensional array of pupils.

FIG. 16B illustrates another example of a waveguide display 1605 including two one-dimensional pupil expanders 1630 and 1640 for two-dimensional pupil replication according to certain embodiments. Each of pupil expanders 1630 and 1640 may be similar to pupil expander 1502 or pupil expander 1504. Pupil expander 1630 may include a waveguide, a variable reflectivity transflective mirror 1632 (e.g., similar to variable reflectivity transflective mirror 1550) on a surface of the waveguide, and an optional reflector 1634 (e.g., similar to mirror 1552) on an opposing surface of the waveguide. Pupil expander 1630 may replicate the pupil through a plurality of regions of variable reflectivity transflective mirror 1632 along approximately the x direction, as described above with respect to, for example, FIGS. 15A and 15B. Light coupled out of pupil expander 1630 may be coupled into pupil expander 1640 through a slanted edge of the waveguide of pupil expander 1640. Pupil expander 1640 may include a waveguide, a variable reflectivity transflective mirror 1642 (e.g., similar to variable reflectivity transflective mirror 1550) or a grating coupler on a surface of the waveguide, and an optional reflector 1644 (e.g., similar to mirror 1552) on an opposing surface of the waveguide. Pupil expander 1640 may replicate the pupil through a plurality of regions of variable reflectivity transflective mirror 1642 along approximately the y direction, as described above with respect to, for example, FIGS. 15A and 15B. Thus, pupil expanders 1630 and 1640 may replicate the pupil along the x and y directions, respectively, to create a two-dimensional array of pupils.

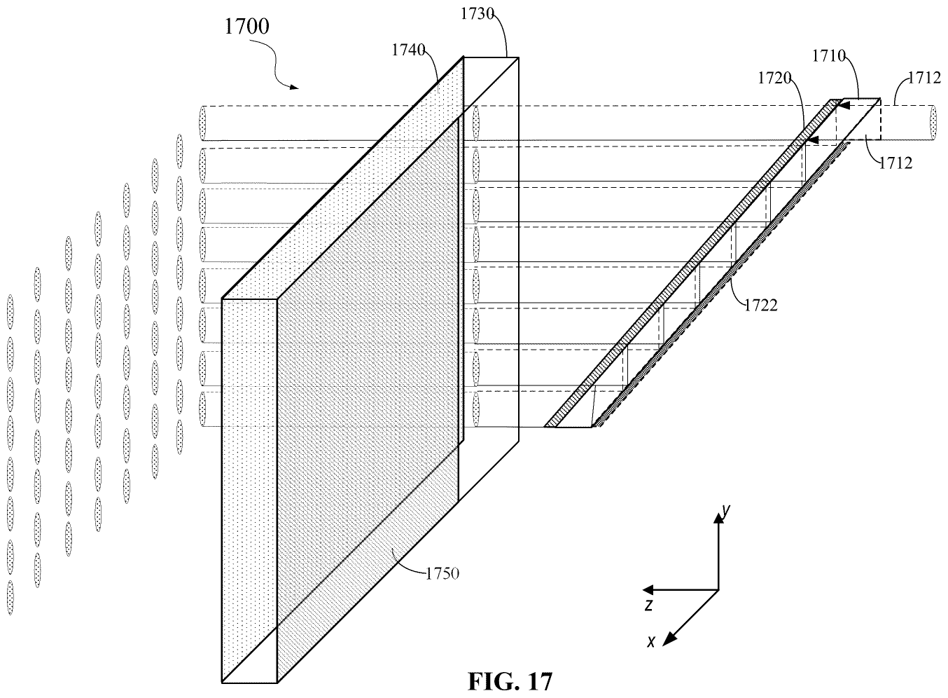

FIG. 17 illustrates another example of a waveguide display 1700 including two one-dimensional pupil expanders 1710 and 1730 for two-dimensional pupil replication according to certain embodiments. Pupil expanders 1710 and 1730 may be similar to pupil expander 1502 or 1504 described above. In the illustrated example, pupil expander 1710 may include a variable reflectivity transflective mirror 1720 on one surface, and an optional reflector 1722 on an opposing surface, as described above with respect to FIG. 15A or 15B. Pupil expander 1710 may have a bar shape and may replicate an input pupil 1712 along one direction (e.g., the y direction) to generate a linear array of pupil. In the illustrated example, pupil expander 1730 may include a variable reflectivity transflective mirror 1740 on one surface, and an optional reflector 1750 on an opposing surface, as described above with respect to FIG. 15A or 15B. Pupil expander 1730 may have a larger area and may replicate the linear array of pupil from pupil expander 1710 along another direction (e.g., the x direction).

In some embodiments, a two-dimensional pupil expander may include a plurality of one-dimensional pupil expanders similar to pupil expander 1502 or 1504. The plurality of one-dimensional pupil expanders may have different thicknesses, and may replicate the pupils with different densities.

Embodiments of the invention may include or be implemented in conjunction with an artificial reality system. Artificial reality is a form of reality that has been adjusted in some manner before presentation to a user, which may include, for example, a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, for example, create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

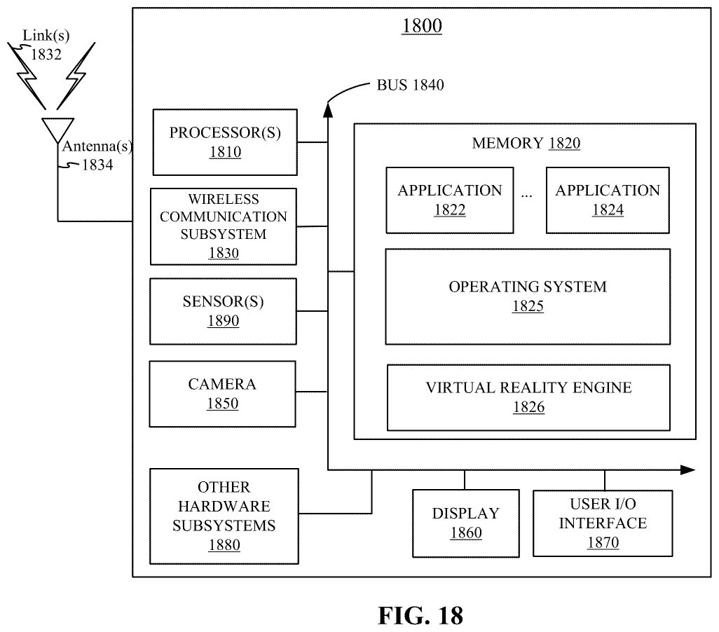

FIG. 18 is a simplified block diagram of an example electronic system 1800 of an example near-eye display (e.g., HMD device) for implementing some of the examples disclosed herein. Electronic system 1800 may be used as the electronic system of an HMD device or other near-eye displays described above. In this example, electronic system 1800 may include one or more processor(s) 1810 and a memory 1820. Processor(s) 1810 may be configured to execute instructions for performing operations at a number of components, and can be, for example, a general-purpose processor or microprocessor suitable for implementation within a portable electronic device. Processor(s) 1810 may be communicatively coupled with a plurality of components within electronic system 1800. To realize this communicative coupling, processor(s) 1810 may communicate with the other illustrated components across a bus 1840. Bus 1840 may be any subsystem adapted to transfer data within electronic system 1800. Bus 1840 may include a plurality of computer buses and additional circuitry to transfer data.

Memory 1820 may be coupled to processor(s) 1810. In some embodiments, memory 1820 may offer both short-term and long-term storage and may be divided into several units. Memory 1820 may be volatile, such as static random access memory (SRAM) and/or dynamic random access memory (DRAM) and/or non-volatile, such as read-only memory (ROM), flash memory, and the like. Furthermore, memory 1820 may include removable storage devices, such as secure digital (SD) cards. Memory 1820 may provide storage of computer-readable instructions, data structures, program code, and other data for electronic system 1800. In some embodiments, memory 1820 may be distributed into different hardware subsystems. A set of instructions and/or code might be stored on memory 1820. The instructions might take the form of executable code that may be executable by electronic system 1800, and/or might take the form of source and/or installable code, which, upon compilation and/or installation on electronic system 1800 (e.g., using any of a variety of generally available compilers, installation programs, compression/decompression utilities, etc.), may take the form of executable code.

In some embodiments, memory 1820 may store a plurality of applications 1822 through 1824, which may include any number of applications. Examples of applications may include gaming applications, conferencing applications, video playback applications, or other suitable applications. The applications may include a depth sensing function or eye tracking function. Applications 1822-1824 may include particular instructions to be executed by processor(s) 1810. In some embodiments, certain applications or parts of applications 1822-1824 may be executable by other hardware subsystems 1880. In certain embodiments, memory 1820 may additionally include secure memory, which may include additional security controls to prevent copying or other unauthorized access to secure information.

In some embodiments, memory 1820 may include an operating system 1825 loaded therein. Operating system 1825 may be operable to initiate the execution of the instructions provided by applications 1822-1824 and/or manage other hardware subsystems 1880 as well as interfaces with a wireless communication subsystem 1830 which may include one or more wireless transceivers. Operating system 1825 may be adapted to perform other operations across the components of electronic system 1800 including threading, resource management, data storage control and other similar functionality.

Wireless communication subsystem 1830 may include, for example, an infrared communication device, a wireless communication device and/or chipset (such as a Bluetooth® device, an IEEE 802.11 device, a Wi-Fi device, a WiMax device, cellular communication facilities, etc.), and/or similar communication interfaces. Electronic system 1800 may include one or more antennas 1834 for wireless communication as part of wireless communication subsystem 1830 or as a separate component coupled to any portion of the system. Depending on desired functionality, wireless communication subsystem 1830 may include separate transceivers to communicate with base transceiver stations and other wireless devices and access points, which may include communicating with different data networks and/or network types, such as wireless wide-area networks (WWANs), wireless local area networks (WLANs), or wireless personal area networks (WPANs). A WWAN may be, for example, a WiMax (IEEE 802.16) network. A WLAN may be, for example, an IEEE 802.11x network. A WPAN may be, for example, a Bluetooth network, an IEEE 802.15x, or some other types of network. The techniques described herein may also be used for any combination of WWAN, WLAN, and/or WPAN. Wireless communications subsystem 1830 may permit data to be exchanged with a network, other computer systems, and/or any other devices described herein. Wireless communication subsystem 1830 may include a means for transmitting or receiving data, such as identifiers of HMD devices, position data, a geographic map, a heat map, photos, or videos, using antenna(s) 1834 and wireless link(s) 1832.

Embodiments of electronic system 1800 may also include one or more sensors 1890. Sensor(s) 1890 may include, for example, an image sensor, an accelerometer, a pressure sensor, a temperature sensor, a proximity sensor, a magnetometer, a gyroscope, an inertial sensor (e.g., a subsystem that combines an accelerometer and a gyroscope), an ambient light sensor, or any other similar devices or subsystems operable to provide sensory output and/or receive sensory input, such as a depth sensor or a position sensor. For example, in some implementations, sensor(s) 1890 may include one or more inertial measurement units (IMUs) and/or one or more position sensors. An IMU may generate calibration data indicating an estimated position of the HMD device relative to an initial position of the HMD device, based on measurement signals received from one or more of the position sensors. A position sensor may generate one or more measurement signals in response to motion of the HMD device. Examples of the position sensors may include, but are not limited to, one or more accelerometers, one or more gyroscopes, one or more magnetometers, another suitable type of sensor that detects motion, a type of sensor used for error correction of the IMU, or some combination thereof. The position sensors may be located external to the IMU, internal to the IMU, or some combination thereof. At least some sensors may use a structured light pattern for sensing.

Electronic system 1800 may include a display 1860. Display 1860 may be a near-eye display, and may graphically present information, such as images, videos, and various instructions, from electronic system 1800 to a user. Such information may be derived from one or more applications 1822-1824, virtual reality engine 1826, one or more other hardware subsystems 1880, a combination thereof, or any other suitable means for resolving graphical content for the user (e.g., by operating system 1825). Display 1860 may use liquid crystal display (LCD) technology, light-emitting diode (LED) technology (including, for example, OLED, ILED, μLED, AMOLED, TOLED, etc.), light emitting polymer display (LPD) technology, or some other display technology.

Electronic system 1800 may include a user input/output interface 1870. User input/output interface 1870 may allow a user to send action requests to electronic system 1800. An action request may be a request to perform a particular action. For example, an action request may be to start or end an application or to perform a particular action within the application. User input/output interface 1870 may include one or more input devices. Example input devices may include a touchscreen, a touch pad, microphone(s), button(s), dial(s), switch(es), a keyboard, a mouse, a game controller, or any other suitable device for receiving action requests and communicating the received action requests to electronic system 1800. In some embodiments, user input/output interface 1870 may provide haptic feedback to the user in accordance with instructions received from electronic system 1800. For example, the haptic feedback may be provided when an action request is received or has been performed.

Electronic system 1800 may include a camera 1850 that may be used to take photos or videos of a user, for example, for tracking the user's eye position. Camera 1850 may also be used to take photos or videos of the environment, for example, for VR, AR, or MR applications. Camera 1850 may include, for example, a complementary metal-oxide-semiconductor (CMOS) image sensor with a few millions or tens of millions of pixels. In some implementations, camera 1850 may include two or more cameras that may be used to capture 3-D images.

In some embodiments, electronic system 1800 may include a plurality of other hardware subsystems 1880. Each of other hardware subsystems 1880 may be a physical subsystem within electronic system 1800. While each of other hardware subsystems 1880 may be permanently configured as a structure, some of other hardware subsystems 1880 may be temporarily configured to perform specific functions or temporarily activated. Examples of other hardware subsystems 1880 may include, for example, an audio output and/or input interface (e.g., a microphone or speaker), a near field communication (NFC) device, a rechargeable battery, a battery management system, a wired/wireless battery charging system, etc. In some embodiments, one or more functions of other hardware subsystems 1880 may be implemented in software.

In some embodiments, memory 1820 of electronic system 1800 may also store a virtual reality engine 1826. Virtual reality engine 1826 may execute applications within electronic system 1800 and receive position information, acceleration information, velocity information, predicted future positions, or some combination thereof of the HMD device from the various sensors. In some embodiments, the information received by virtual reality engine 1826 may be used for producing a signal (e.g., display instructions) to display 1860. For example, if the received information indicates that the user has looked to the left, virtual reality engine 1826 may generate content for the HMD device that mirrors the user's movement in a virtual environment. Additionally, virtual reality engine 1826 may perform an action within an application in response to an action request received from user input/output interface 1870 and provide feedback to the user. The provided feedback may be visual, audible, or haptic feedback. In some implementations, processor(s) 1810 may include one or more GPUs that may execute virtual reality engine 1826.

In various implementations, the above-described hardware and subsystems may be implemented on a single device or on multiple devices that can communicate with one another using wired or wireless connections. For example, in some implementations, some components or subsystems, such as GPUs, virtual reality engine 1826, and applications (e.g., tracking application), may be implemented on a console separate from the head-mounted display device. In some implementations, one console may be connected to or support more than one HMD.

In alternative configurations, different and/or additional components may be included in electronic system 1800. Similarly, functionality of one or more of the components can be distributed among the components in a manner different from the manner described above. For example, in some embodiments, electronic system 1800 may be modified to include other system environments, such as an AR system environment and/or an MR environment.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, systems, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing various embodiments. Various changes may be made in the function and arrangement of elements without departing from the spirit and scope of the present disclosure.

Also, some embodiments were described as processes depicted as flow diagrams or block diagrams. Although each may describe the operations as a sequential process, many of the operations may be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

It will be apparent to those skilled in the art that substantial variations may be made in accordance with specific requirements. For example, customized or special-purpose hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium,” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including, but not limited to, non-volatile media, volatile media, and transmission media. Common forms of computer-readable media include, for example, magnetic and/or optical media such as compact disk (CD) or digital versatile disk (DVD), punch cards, paper tape, any other physical medium with patterns of holes, a RAM, a programmable read-only memory (PROM), an erasable programmable read-only memory (EPROM), a FLASH-EPROM, any other memory chip or cartridge, a carrier wave as described hereinafter, or any other medium from which a computer can read instructions and/or code. A computer program product may include code and/or machine-executable instructions that may represent a procedure, a function, a subprogram, a program, a routine, an application (App), a subroutine, a module, a software package, a class, or any combination of instructions, data structures, or program statements.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms, “and” and “or” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean A, B, C, or a combination of A, B, and/or C, such as AB, AC, BC, AA, ABC, AAB, ACC, AABBCCC, or the like.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented with a computer program product containing computer program code or instructions executable by one or more processors for performing any or all of the steps, operations, or processes described in this disclosure, where the computer program may be stored on a non-transitory computer readable medium. The various processes described herein can be implemented on the same processor or different processors in any combination.

Where devices, systems, components, or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques, including, but not limited to, conventional techniques for inter-process communications, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

Embodiments disclosed herein may include different combinations of features in view of the description. Certain embodiments are described in the following examples.

In Example 1, a pupil expander of a near-eye display comprises a waveguide transparent to display light and configured to guide the display light along a first direction, and a partial reflective mirror on a first surface of the waveguide, wherein the partial reflective mirror is parallel to the first direction and is characterized by different reflectivity at a plurality of regions along the first direction, and wherein each region of the plurality of regions of the partial reflective mirror is configured to partially reflect incident light and partially transmit the incident light through the region of the plurality of regions of the partial reflective mirror.

Example 2 includes the pupil expander of Example 1, wherein the reflectivity at the plurality of regions of the partial reflective mirror increases along the first direction.

Example 3 includes the pupil expander of Example 2, wherein the reflectivity at each respective region of the plurality of regions of the partial reflective mirror is uniform within the respective region.

Example 4 includes the pupil expander of Example 2, wherein the reflectivity of the partial reflective mirror increases continuously along the first direction.

Example 5 includes the pupil expander of any of Examples 1-4, wherein the waveguide is configured to reflect the display light at a second surface opposing the first surface by total internal reflection.

Example 6 includes the pupil expander of any of Examples 1-4, wherein the pupil expander further comprises a reflector on a second surface of the waveguide opposing the first surface, wherein the reflector is configured to reflect the display light reflected by a region of the plurality of regions of the partial reflective mirror towards another region of the plurality of regions of the partial reflective mirror.

Example 7 includes the pupil expander of any of Examples 1-6, wherein the waveguide has a bar shape and extends in the first direction.

Example 8 includes the pupil expander of any of Examples 1-6, wherein the waveguide is configured to receive an array of pupils replicated along a second direction and replicate the array of pupils along the first direction.

Example 9 includes the pupil expander of any of Examples 1-8, wherein the pupil expander further comprises one or more partial reflective mirrors embedded in the waveguide and parallel to a surface of the waveguide and the first direction.

Example 10 includes a near-eye display comprising:
a first pupil expander extending in a first direction, the first pupil expander comprising:
   a first waveguide transparent to display light and configured to guide the display light along the first direction; and
   a first partial reflective mirror on a first surface of the first waveguide, wherein the first partial reflective mirror is parallel to the first direction and is characterized by different reflectivity at a first plurality of regions along the first direction,
   wherein each region of the first plurality of regions of the first partial reflective mirror is configured to partially reflect incident light and partially transmit the incident light through the region of the first plurality of regions of the first partial reflective mirror; and
a second pupil expander configured to split the display light transmitted from each region of the first plurality of regions of the first partial reflective mirror at a second plurality of regions along a second direction that is different from the first direction.

Example 11 includes the near-eye display of Example 10, wherein the reflectivity at the first plurality of regions of the first partial reflective mirror increases along the first direction.

Example 12 includes the near-eye display of Example 11, wherein the reflectivity at each respective region of the first plurality of regions of the first partial reflective mirror is uniform within the respective region.

Example 13 includes the near-eye display of Example 11, wherein the reflectivity at the first plurality of regions of the first partial reflective mirror increases continuously along the first direction.

Example 14 includes the near-eye display of any of Examples 10-13, wherein the first waveguide of the first pupil expander is configured to reflect the display light at a second surface opposing the first surface by total internal reflection.

Example 15 includes the near-eye display of any of Examples 10-13, wherein the first pupil expander includes a first reflector on a second surface of the first waveguide opposing the first surface, the first reflector configured to reflect the display light reflected by a region of the first plurality of regions of the first partial reflective mirror towards another region of the first plurality of regions of the first partial reflective mirror.

Example 16 includes the near-eye display of any of Examples 10-15, wherein the second pupil expander comprises: a second waveguide configured to guide the display light along the second direction; and a second partial reflective mirror on a first surface of the second waveguide, wherein the second partial reflective mirror is parallel to the second direction and is characterized by different reflectivity at the second plurality of regions along the second direction, and wherein each region of the second plurality of regions of the second partial reflective mirror is configured to partially reflect incident light and partially transmit the incident light through the region of the second plurality of regions of the second partial reflective mirror.

Example 17 includes the near-eye display of Example 16, wherein the second waveguide of the second pupil expander is configured to reflect the display light at a second surface opposing the first surface of the second waveguide by total internal reflection.

Example 18 includes the near-eye display of Example 16, wherein the second pupil expander further comprises a second reflector on a second surface of the second waveguide opposing the first surface of the second waveguide, the second reflector configured to reflect the display light reflected by a region of the second plurality of regions of the second partial reflective mirror towards another region of the second plurality of regions of the second partial reflective mirror.

Example 19 includes the near-eye display of Example 16, wherein the second pupil expander includes one or more grating couplers configured to couple the display light into and/or out of the second waveguide.

Example 20 includes the near-eye display of any of Example 10-19, wherein the first pupil expander includes one or more partial reflective mirrors embedded in the first waveguide and parallel to a surface of the first waveguide and the first direction.

Example 21 includes a pupil expander of a near-eye display, the pupil expander comprising: a waveguide transparent to display light and configured to guide the display light along a first direction; and two or more partial reflective mirrors embedded in the waveguide and parallel to a surface of the waveguide and the first direction.

Example 22 includes the pupil expander of Example 21, wherein the pupil expander includes an output coupler configured to couple the display light out of the waveguide at a plurality of locations along the first direction, the output coupler comprising a surface-relief grating, a holographic grating, a polarization volume hologram, an array of partially reflective mirrors embedded in the waveguide, or an array of micro-mirrors formed at a surface of the waveguide.

Example 23 includes the pupil expander of Example 21 or 22, wherein the two or more partial reflective mirrors are evenly distributed in the waveguide along a second direction that is perpendicular to the first direction.

Example 24 includes the pupil expander of any of Examples 21-23, wherein the waveguide includes a plurality of stacked substrates.

Example 25 includes the pupil expander of Example 24, wherein each of the two or more partial reflective mirrors is formed on a substrate of the plurality of stacked substrates.

Example 26 includes the pupil expander of any of Examples 21-25, wherein each of the two or more partial reflective mirrors is characterized by a reflectivity about 50%.

Example 27 includes a near-eye display, the near-eye display comprising:
a first pupil expander extending in a first direction, the first pupil expander comprising:
   a first waveguide transparent to display light and configured to guide the display light along the first direction; and
   two or more partial reflective mirrors embedded in the first waveguide and parallel to a surface of the first waveguide and the first direction; and
a second pupil expander configured to split the display light from each location of the first plurality of locations of the first pupil expander at a second plurality of locations along a second direction that is different from the first direction.

Example 28 includes the near-eye display of Example 27, wherein the first pupil expander includes a first output coupler configured to couple the display light out of the first waveguide at a first plurality of locations of the first pupil expander along the first direction, the first output coupler comprising a surface-relief grating, a holographic grating, a polarization volume hologram, an array of partially reflective mirrors embedded in the first waveguide, or an array of micro-mirrors formed at a surface of the first waveguide.

Example 29 includes the near-eye display of Example 27 or 28, wherein the two or more partial reflective mirrors are evenly distributed in the first waveguide along a direction that is perpendicular to the first direction.

Example 30 includes the near-eye display of any of Examples 27-29, wherein each of the two or more partial reflective mirrors is characterized by a reflectivity about 50%.

Example 31 includes the near-eye display of any of Examples 27-30, wherein the second pupil expander comprises: a second waveguide transparent to the display light and configured to guide the display light along the second direction; two or more partial reflective mirrors embedded in the second waveguide and parallel to a surface of the second waveguide and the second direction; and a second output coupler configured to couple the display light out of the second waveguide at the second plurality of locations of the second pupil expander along the second direction.

What is claimed is:

1. A pupil expander of a near-eye display, the pupil expander comprising:
a waveguide transparent to display light and configured to guide the display light along a first direction; and
a partial reflective mirror on a first surface of the waveguide, wherein the partial reflective mirror is parallel to the first direction and is characterized by different reflectivity at a plurality of regions along the first direction,
wherein each region of the plurality of regions of the partial reflective mirror is configured to partially reflect incident light and partially transmit the incident light through the region of the plurality of regions of the partial reflective mirror.

2. The pupil expander of claim 1, wherein the reflectivity at the plurality of regions of the partial reflective mirror increases along the first direction.

3. The pupil expander of claim 2, wherein reflectivity at each respective region of the plurality of regions of the partial reflective mirror is uniform within the respective region.

4. The pupil expander of claim 2, wherein reflectivity of the partial reflective mirror increases continuously along the first direction.

5. The pupil expander of claim 1, wherein the waveguide is configured to reflect the display light at a second surface opposing the first surface by total internal reflection.

6. The pupil expander of claim 1, further comprising a reflector on a second surface of the waveguide opposing the first surface, wherein the reflector is configured to reflect the display light reflected by a region of the plurality of regions of the partial reflective mirror towards another region of the plurality of regions of the partial reflective mirror.

7. The pupil expander of claim 1, wherein the waveguide has a bar shape and extends in the first direction.

8. The pupil expander of claim 1, wherein the waveguide is configured to receive an array of pupils replicated along a second direction and replicate the array of pupils along the first direction.

9. The pupil expander of claim 1, further comprising one or more partial reflective mirrors embedded in the waveguide and parallel to a surface of the waveguide and the first direction.

10. A near-eye display comprising:
a first pupil expander extending in a first direction, the first pupil expander comprising:
a first waveguide transparent to display light and configured to guide the display light along the first direction; and
a first partial reflective mirror on a first surface of the first waveguide, wherein the first partial reflective mirror is parallel to the first direction and is characterized by different reflectivity at a first plurality of regions along the first direction,
wherein each region of the first plurality of regions of the first partial reflective mirror is configured to partially reflect incident light and partially transmit the incident light through the region of the first plurality of regions of the first partial reflective mirror; and
a second pupil expander configured to split the display light transmitted from each region of the first plurality of regions of the first partial reflective mirror at a second plurality of regions along a second direction that is different from the first direction.

11. The near-eye display of claim 10, wherein the reflectivity at the first plurality of regions of the first partial reflective mirror increases along the first direction.

12. The near-eye display of claim 11, wherein reflectivity at each respective region of the first plurality of regions of the first partial reflective mirror is uniform within the respective region.

13. The near-eye display of claim 11, wherein reflectivity of the first partial reflective mirror increases continuously along the first direction.

14. The near-eye display of claim 10, wherein the first waveguide of the first pupil expander is configured to reflect the display light at a second surface opposing the first surface by total internal reflection.

15. The near-eye display of claim 10, wherein the first pupil expander includes a first reflector on a second surface of the first waveguide opposing the first surface, the first reflector configured to reflect the display light reflected by a region of the first plurality of regions of the first partial reflective mirror towards another region of the first plurality of regions of the first partial reflective mirror.

16. The near-eye display of claim 10, wherein the second pupil expander comprises:
a second waveguide configured to guide the display light along the second direction; and
a second partial reflective mirror on a first surface of the second waveguide, wherein the second partial reflective mirror is parallel to the second direction and is characterized by different reflectivity at the second plurality of regions along the second direction,
wherein each region of the second plurality of regions of the second partial reflective mirror is configured to partially reflect incident light and partially transmit the incident light through the region of the second plurality of regions of the second partial reflective mirror.

17. The near-eye display of claim 16, wherein the second waveguide of the second pupil expander is configured to reflect the display light at a second surface opposing the first surface of the second waveguide by total internal reflection.

18. The near-eye display of claim 16, wherein the second pupil expander further comprises a second reflector on a second surface of the second waveguide opposing the first surface of the second waveguide, the second reflector configured to reflect the display light reflected by a region of the second plurality of regions of the second partial reflective mirror towards another region of the second plurality of regions of the second partial reflective mirror.

19. The near-eye display of claim 16, wherein the second pupil expander includes one or more grating couplers configured to couple the display light into and/or out of the second waveguide.

20. The near-eye display of claim 10, wherein the first pupil expander includes one or more partial reflective mirrors embedded in the first waveguide and parallel to a surface of the first waveguide and the first direction.
